(19) United States
(12) Patent Application Publication
(10) Pub. No.: US 2024/0386119 A1
(43) Pub. Date: Nov. 21, 2024

(54) Access Control

(71) Applicant: FEATURESPACE LIMITED, Cambridge, Cambridgeshire (GB)

(72) Inventor: Simon Cooper, Cambridge (GB)

(21) Appl. No.: 17/922,521

(22) PCT Filed: Aug. 26, 2022
(86) PCT No.: PCT/IB2022/057999

§ 371 Date: Oct. 31, 2022

(51) Int. Cl. G06F 21/62

(52) U.S. Cl. CPC G06F 21/6218

(57) ABSTRACT

A method of controlling access to machine learning model data in a multi-tenant machine learning system having a machine learning model data access hierarchy. The hierarchy comprises: (i) a tenant level comprising first and second tenants associated with first and second tenant machine learning model data respectively; and (ii) a tenant group level comprising a tenant group to which the first and second tenants belong. The tenant group is associated with tenant group machine learning model data. The tenant group machine learning model data is based on the first and/or second tenant machine learning model data. The method comprises, for a machine learning model being applied in respect of the first tenant at the tenant group level: (i) allowing access to the tenant group machine learning model data and the first tenant machine learning model data; and (ii) inhibiting access to the second tenant machine learning model data.

### TECHNICAL FIELD

The present disclosure relates to access control. In particular, but not exclusively, the present disclosure relates to methods of controlling access to machine learning model data in a multi-tenant machine learning system having a machine learning model data access hierarchy and to multi-tenant machine learning systems. In examples, the methods and systems are used to detect anomalies in patterns of data, e.g. to detect fraudulent transactions. Certain examples relate to real-time transaction processing methods and systems.

### BACKGROUND ART

Digital payments have exploded over the last twenty years, with more than three-quarters of global payments using some form of payment card or electronic wallet. Point of sale systems are progressively becoming digital rather than cash-based. Put simply, global systems of commerce are now heavily reliant on electronic data processing platforms. This presents many engineering challenges that are primarily hidden from a lay user. For example, digital transactions need to be completed in real-time, i.e. with a minimal level of delay experienced by computer devices at the point of purchase. Digital transactions also need to be secure and resistant to attack and exploitation. The processing of digital transactions is also constrained by the historic development of global electronic systems for payments. For example, much infrastructure is still configured around models that were designed for mainframe architectures in use over 50 years ago.

As digital transactions increase, new security risks also become apparent. Digital transactions present new opportunities for fraud and malicious activity. In 2015, it was estimated that 7% of digital transactions were fraudulent, and that figure has only increased with the transition of more economic activity online. Fraud losses are estimated to be four times the population of the world (e.g., in US dollars) and are growing.

Financial Services institutions are becoming subject to more regulatory scrutiny as traditional methods of fraud prevention, such as authentication of identity (e.g. passwords, digital biometrics, national ID, and the like) have proven to be ineffective at preventing fraud vectors such as synthetic identities and scams. These far more complicated threat vectors for fraud require significantly more analytics in a very short (sub 50 millisecond (ms)) time, and are often based on a much smaller data sampling size for the scam or fraud itself. This imposes significant technical challenges.

While risks like fraud are an economic issue for companies involved in commerce, the implementation of technical systems for processing transactions is an engineering challenge. Traditionally, banks, merchants and card issuers developed “paper” rules or procedures that were manually implemented by clerks to flag or block certain transactions. As transactions became digital, one approach to building technical systems for processing transactions has been to supply computer engineers with these sets of developed criteria and to ask the computer engineers to implement them using digital representations of the transactions, i.e. convert the hand-written rules into coded logic statements that may be applied to electronic transaction data. This traditional approach has run into several problems as digital transaction volumes have grown. First, any applied processing needs to take place at “real-time”, e.g. with millisecond latencies. Second, many thousands of transactions need to be processed every second (e.g., a common “load” may be 1000-2000 per second), with load varying unexpectedly over time (e.g., a launch of a new product or a set of tickets can easily increase an average load level by several multiples). Third, the digital storage systems of transaction processors and banks are often siloed or partitioned for security reasons, yet digital transactions often involve an interconnected web of merchant systems. Fourthly, large scale analysis of actual reported fraud and predicted fraud is now possible. This shows that traditional approaches to fraud detection are found wanting; accuracy is low and false positives are high. This then has a physical effect on digital transaction processing, more genuine point-of-sale and online purchases are declined and those seeking to exploit the new digital systems often get away with it.

In the last few years, a more machine learning approach has been taken to the processing of transaction data. As machine learning models mature in academia, engineers have begun to attempt to apply them to the processing of transaction data. However, this again runs into problems. Even if engineers are provided with an academic or theoretical machine learning model and asked to implement it, this is not straightforward. For example, the problems of large-scale transaction processing systems come into play. Machine learning models do not have the luxury of unlimited inference time as in the laboratory. This means that it is simply not practical to implement certain models in a real-time setting, or that they need significant adaptation to allow real-time processing in the volume levels experienced by real-world servers. Moreover, engineers need to contend with the problem of implementing machine learning models on data that is siloed or partitioned based on access security, and in situations where the velocity of data updates is extreme. The problems faced by engineers building transaction processing systems may thus be seen as akin to those faced by network or database engineers; machine learning models need to be applied but meeting system throughput and query response time constraints set by the processing infrastructure. There are no easy solutions to these problems. Indeed, the fact that many transaction processing systems are confidential, proprietary, and based on old technologies means that engineers do not have the body of knowledge developed in these neighbouring fields and often face challenges that are unique to the field of transaction processing. Moreover, the field of large-scale practical machine learning is still young, and there are few established design patterns or textbooks that engineers can rely on.

### SUMMARY OF THE INVENTION

According to a first aspect, there is provided a method of controlling access to machine learning model data in a multi-tenant machine learning system having a machine learning model data access hierarchy, the machine learning model data access hierarchy comprising:
a tenant level comprising first and second tenants associated with first and second tenant machine learning model data respectively; and
a tenant group level comprising a tenant group to which the first and second tenants belong, wherein the tenant group is associated with tenant group machine learning model data, and wherein the tenant group machine learning model data is based on the first and/or second tenant machine learning model data,
the method comprising, for a machine learning model being applied in respect of the first tenant at the tenant group level:
   allowing access to the tenant group machine learning model data and the first tenant machine learning model data; and
   inhibiting access to the second tenant machine learning model data.

According to a second aspect, there is provided a method of controlling access to learning model data in a multi-tenant system having a learning model data access hierarchy, the learning model data access hierarchy comprising:
a tenant level comprising first and second tenants associated with first and second tenant learning model data respectively; and
a tenant group level comprising a tenant group to which at least the first tenant belongs, wherein the tenant group is associated with tenant group learning model data, and wherein the tenant group learning model data is based at least on the first tenant learning model data,
the method comprising, for a learning model being applied in respect of the first tenant at the tenant group level and/or for a learning model being applied in respect of the first tenant at the tenant level:
   allowing access to the tenant group learning model data and the first tenant learning model data; and
   inhibiting access to the second tenant learning model data.

According to a third aspect, there is provided a method of controlling access to machine learning model data in a multi-tenant machine learning system having a machine learning model data access hierarchy, the machine learning model data access hierarchy comprising:
a first tenant associated with first tenant machine learning model data;
a second tenant associated with second tenant machine learning model data; and
a tenant group associated with tenant group machine learning model data,
the method comprising controlling access to machine learning model data such that:
   at a first time:
      the first tenant belongs to the tenant group and the second tenant does not belong to the tenant group; and
      the tenant group machine learning model data is based on the first tenant machine learning model data and the tenant group machine learning model data is not based on the second tenant machine learning model data;
   at a second, later time:
      the first and second tenant belong to the tenant group; and
      the tenant group machine learning model data is based at least on the first tenant machine learning model data; and
   at a third, later time:
      the tenant group machine learning model data is based on the first and second tenant machine learning model data.

According to a fourth aspect, there is provided a multi-tenant machine learning system configured to perform a method provided according to the first, second and/or third embodiments.

According to a fifth aspect, there is provided a multi-tenant machine learning system having access to a machine learning model data access hierarchy comprising multiple tenants and one or more tenant groups, the multi-tenant machine learning system comprising a machine learning model data access controller configured to control access to machine learning model data in accordance with the machine learning model data access hierarchy.

Embodiments of the present invention may be applied to a wide variety of digital transactions, including, but not limited to, card payments, so-called “wire” transfers, peer-to-peer payments, Bankers' Automated Clearing System (BACS) payments, and Automated Clearing House (ACH) payments. The output of the machine learning system may be used to prevent a wide variety of fraudulent and criminal behaviour such as card fraud, application fraud, payment fraud, merchant fraud, gaming fraud and money laundering.

### BRIEF DESCRIPTION OF THE DRAWINGS

Certain embodiments of the present invention will now be described with reference to the accompanying drawings, in which:

FIGS. 1A to 1C are schematic diagrams showing different example electronic infrastructures for transaction processing;

FIGS. 2A and 2B are schematic diagrams showing different examples of data storage systems for use by a machine learning transaction processing system;

FIGS. 3A and 3B are schematic diagrams showing different examples of transaction data.

FIG. 4 is a schematic diagram showing example components of a machine learning transaction processing system;

FIGS. 5A and 5B are sequence diagrams showing an example set of processes performed by different computing entities on transaction data;

FIG. 6 is a schematic diagram showing an example of a machine learning model data access hierarchy;

FIG. 7 is a schematic diagram showing another example of a machine learning model data access hierarchy;

FIG. 7 is a schematic diagram showing another example of a machine learning model data access hierarchy;

FIG. 8 is a schematic diagram showing another example of a machine learning model data access hierarchy;

FIG. 9 is a schematic diagram showing another example of a machine learning model data access hierarchy;

FIG. 10 is a schematic diagram showing another example of a machine learning model data access hierarchy;

FIG. 11 is a schematic diagram showing another example of a machine learning model data access hierarchy;

FIG. 12 is a schematic diagram showing another example of a machine learning model data access hierarchy;

FIG. 13 is a schematic diagram showing another example of a machine learning model data access hierarchy;

FIG. 14 is a schematic diagram showing another example of a machine learning model data access hierarchy;

FIG. 15 is a schematic diagram showing another example of a machine learning model data access hierarchy;

FIG. 16 is a schematic diagram showing another example of a machine learning model data access hierarchy;

FIG. 17 is a schematic diagram showing another example of a machine learning model data access hierarchy;

FIG. 18 is a schematic diagram showing another example of a machine learning model data access hierarchy;

FIG. 19 is a schematic diagram showing another example of a machine learning model data access hierarchy;

FIG. 20 is a schematic diagram showing another example of a machine learning model data access hierarchy;

FIG. 21 is flow diagram showing an example of a method of controlling access to machine learning model data;

FIG. 22 is a block diagram illustrating an example of a multi-tenant machine learning system;

FIG. 23 is a schematic diagram showing another example of a machine learning model data access hierarchy;

FIG. 24 is a schematic diagram showing another example of a machine learning model data access hierarchy; and

FIG. 25 is a schematic diagram showing another example of a machine learning model data access hierarchy.

### DETAILED DESCRIPTION

Certain exemplary embodiments are described herein which relate to a machine learning system for use in transaction processing. In certain embodiments, a machine learning system is applied in real-time, high-volume transaction processing pipelines to provide an indication of whether a transaction or entity matches previously observed and/or predicted patterns of activity or actions, e.g. an indication of whether a transaction or entity is “normal” or “anomalous”. The term “behavioural” is used herein to refer to this pattern of activity or actions. The indication may comprise a scalar value normalised within a predefined range (e.g., 0 to 1) that is then useable to prevent fraud and other misuse of payment systems. The machine learning systems may apply machine learning models that are updated as more transaction data is obtained, e.g. that are constantly trained based on new data, so as to reduce false positives and maintain accuracy of the output metric. The present examples may be particularly useful for preventing fraud in cases where the physical presence of a payment card cannot be ascertained (e.g., online transactions referred to as “card-not-present”) or for commercial transactions where high-value transactions may be routine and where it may be difficult to classify patterns of behaviour as “unexpected”. As such, the present examples facilitate the processing of transactions as these transactions to being primarily “online”, i.e. conducted digitally over one or more public communications networks.

Certain embodiments described herein allow machine learning models to be tailored to be specific to patterns of behaviour between certain pairs of entities (such as account holders) and categories (such as merchants, transaction amounts, times of day, and others). For example, the machine learning models may model entity-category-pair specific patterns of behaviour. The machine learning systems described herein are able to provide dynamically updating machine learning models despite large transaction flows and/or despite the need for segregation of different data sources.

As outlined previously, embodiments of the present invention may be applied to a wide variety of digital transactions, including, but not limited to, card payments, so-called “wire” transfers, peer-to-peer payments, Bankers' Automated Clearing System (BACS) payments, and Automated Clearing House (ACH) payments. The output of the machine learning system may be used to prevent a wide variety of fraudulent and criminal behaviour such as card fraud, application fraud, payment fraud, merchant fraud, gaming fraud and money laundering.

### Terms

In the context of this specification “comprising” is to be interpreted as “including”. Aspects of the invention comprising certain elements are also intended to extend to alternative embodiments “consisting” or “consisting essentially” of the relevant elements.

The terms “behaviour” and “behavioural” are used herein to refer to a pattern of activity or actions.

The term “memory” or “memory store” should be understood to mean any means suitable for the storage of data and includes both volatile and non-volatile memory as appropriate for the intended application. Those skilled in the art will appreciate that this includes, but is not limited to, random access memory (RAM), static RAM (SRAM), dynamic RAM (DRAM), magnetic storage, solid-state storage, and flash memory. It will be appreciated that combinations of one or more of these may also be used for the storage of data, as technically appropriate (e.g. using faster access volatile memory for frequently accessed data).

The term “data” is used in different contexts herein to refer to digital information, such as that represented by known bit structures within one or more programming languages. In use, data may refer to digital information that is stored as bit sequences within computer memory. Certain machine learning models may operate on structured arrays of data of a predefined bit format. Those skilled in the art will readily appreciated that these may be referred to as arrays, multidimensional arrays, matrices, vectors, tensors, or other such similar terms. It should be noted that for machine learning methods multidimensional arrays or tensors, e.g. with a defined extent in multiple dimensions, may be “flattened” so as to be represented (e.g., within memory) as a sequence or vector of values stored according to the predefined format (e.g., n-bit integer or floating point number, signed or unsigned). Hence, the term “tensor” as used herein covers multidimensional arrays with one or more dimensions (e.g., vectors, matrixes, volumetric arrays etc).

The principles of the present invention apply irrespective of the particular data format chosen. Data may be represented as arrays, vectors, tensors, or any other suitable format. For ease of reference, these terms are used interchangeably herein, and references to a “vector” or “vectors” of values should be understood to extend to any n-dimensional tensor or tensors of values as appropriate. Similarly, references to a “tensor” or “tensors” of values should be understood to extend to vectors, which are understood by those skilled in the art to simply be one-dimensional tensors. The principles of the present invention may be applied regardless of the formatting of the data structures used for these arrays of values. For example, state data may be stored in memory as one-dimensional tensors (i.e. vectors) or as a tensor with dimensionality of two or greater (i.e. tensors), and those skilled in the art will readily understand that suitable modifications can be made to the data processing elements to handle the selected data format. The relative positions between various state values, e.g. how they are ordered within a vector or tensor, do not generally matter, and the scope of the present invention is not limited to any particular data format or structure.

The term “structured numeric representation” is used to refer to numeric data in a structured form, such as an array of one or more dimensions that stores numeric values with a common data type, such as integers or float values. A structured numeric representation may comprise a vector or tensor (as used within machine learning terminology). A structured numeric representation is typically stored as a set of indexed and/or consecutive memory locations, e.g. a one-dimensional array of 64-bit floats may be represented in computer memory as a consecutive sequence of 64-bit memory locations in a 64-bit computing system.

The term “transaction data” is used herein to refer to electronic data that is associated with a transaction. A transaction comprises a series of communications between different electronic systems to implement a payment or exchange. In general, transaction data may comprise data indicating events (e.g., actions undertaken in time) that relate to, and may be informative for, transaction processing. Transaction data may comprise structured, unstructured and semi-structured data, or any combination thereof. Transaction data may also include data associated with a transaction, such as data used to process a transaction. In certain cases, transaction data may be used broadly to refer actions taken with respect to one or more electronic devices. Transaction data may take a variety of forms depending on the precise implementation. However, different data types and formats may be converted by pre or post processing as appropriate.

The term “interface” is used herein to refer to any physical and/or logical interface that allows for one or more of data input and data output. An interface may be implemented by a network interface adapted to send and/or receive data, or by retrieving data from one or more memory locations, as implemented by a processor executing a set of instructions. An interface may also comprise physical (network) couplings over which data is received, such as hardware to allow for wired or wireless communications over a particular medium. An interface may comprise an application programming interface and/or a method call or return. For example, in a software implementation, an interface may comprise passing data and/or memory references to a function initiated via a method call, where the function comprises computer program code that is executed by one or more processors; in a hardware implementation, an interface may comprise a wired interconnect between different chips, chipsets or portions of chips. In the drawings, an interface may be indicated by a boundary of a processing block that has an inward and/or outward arrow representing a data transfer.

The terms “component” and “module” are used interchangeably to refer to either a hardware structure that has a specific function (e.g., in the form of mapping input data to output data) or a combination of general hardware and specific software (e.g., specific computer program code that is executed on one or more general purpose processors). A component or module may be implemented as a specific packaged chipset, for example, an Application Specific Integrated Circuit (ASIC) or a programmed Field Programmable Gate Array (FPGA), and/or as a software object, class, class instance, script, code portion or the like, as executed in use by a processor.

The term “machine learning model” is used herein to refer to at least a hardware-executed implementation of a machine learning model or function. Known models within the field of machine learning include logistic regression models, Naïve Bayes models, Random Forests, Support Vector Machines and artificial neural networks. Implementations of classifiers may be provided within one or more machine learning programming libraries including, but not limited to, scikit-learn, TensorFlow, and PyTorch.

The term “map” is used herein to refer to the transformation or conversion of a first set of data values to a second set of data values. The two sets of data values may be arrays of different sizes, with an output array being of lower dimensionality than an input array. The input and output arrays may have common or different data types. In certain examples, the mapping is a one-way mapping to a scalar value.

The term “neural network architecture” refers to a set of one or more artificial neural networks that are configured to perform a particular data processing task. For example, a “neural network architecture” may comprise a particular arrangement of one or more neural network layers of one or more neural network types. Neural network types include convolutional neural networks, recurrent neural networks, and feedforward neural networks. Convolutional neural networks involve the application of one or more convolution operations. Recurrent neural networks involve an internal state that is updated during a sequence of inputs. Recurrent neural networks are thus seen as including a form of recurrent or feedback connection whereby a state of the recurrent neural network at a given time or iteration (e.g., t) is updated using a state of the recurrent neural network at a previous time or iteration (e.g., t−1). Feedforward neural networks involve transformation operations with no feedback, e.g. operations are applied in a one-way sequence from input to output. Feedforward neural networks include plain “neural networks” and “fully-connected” neural networks”. Those skilled in the art will appreciate that a “multilayer perceptron” is a term used to describe a fully-connected layer, and is a special case of a feedforward neural network.

The term “deep” neural network is used to indicates that the neural network comprises multiple neural network layers in series (it should be noted this “deep” terminology is used with both feedforward neural networks and recurrent neural networks). Certain examples described herein make use of recurrent and fully-connected neural networks.

A “neural network layer”, as typically defined within machine learning programming tools and libraries, may be considered an operation that maps input data to output data. A “neural network layer” may apply one or more parameters such as weights to map input data to output data. One or more bias terms may also be applied. The weights and biases of a neural network layer may be applied using one or more multidimensional arrays or matrices. In general, a neural network layer has a plurality of parameters whose value influence how input data is mapped to output data by the layer. These parameters may be trained in a supervised manner by optimizing an objective function. This typically involves minimizing a loss function. Certain parameters may also be pre-trained or fixed in another manner. Fixed parameters may be considered as configuration data that controls the operation of the neural network layer. A neural network layer or architecture may comprise a mixture of fixed and learnable parameters. A recurrent neural network layer may apply a series of operations to update a recurrent state and transform input data. The update of the recurrent state and the transformation of the input data may involve transformations of one or more of a previous recurrent state and the input data. A recurrent neural network layer may be trained by unrolling a modelled recurrent unit, as may be applied within machine learning programming tools and libraries. Although a recurrent neural network may be seen to comprise several (sub) layers to apply different gating operations, most machine learning programming tools and libraries refer to the application of the recurrent neural network as a whole as a “neural network layer” and this convention will be followed here. Lastly, a feedforward neural network layer may apply one or more of a set of weights and biases to input data to generate output data. This operation may be represented as a matrix operation (e.g., where a bias term may be included by appending a value of 1 onto input data). Alternatively, a bias may be applied through a separate addition operation. As discussed above, the term “tensor” is used, as per machine learning libraries, to refer to an array that may have multiple dimensions, e.g. a tensor may comprise a vector, a matrix or a higher dimensionality data structure. In preferred example, described tensors may comprise vectors with a predefined number of elements.

To model complex non-linear functions, a neural network layer as described above may be followed by a non-linear activation function. Common activation functions include the sigmoid function, the tan h function, and Rectified Linear Units (RELUs). Many other activation functions exist and may be applied. An activation function may be selected based on testing and preference. Activation functions may be omitted in certain circumstances, and/or form part of the internal structure of a neural network layer. The example neural network architectures described herein may be configured via training. In certain cases, “learnable” or “trainable” parameters may be trained using an approach called backpropagation. During backpropagation, the neural network layers that make up each neural network architecture are initialized (e.g., with randomized weights) and then used to make a prediction using a set of input data from a training set (e.g., a so-called “forward” pass). The prediction is used to evaluate a loss function. For example, a “ground-truth” output may be compared with a predicted output, and the difference may form part of the loss function. In certain examples, a loss function may be based on an absolute difference between a predicted scalar value and a binary ground truth label. The training set may comprise a set of transactions. If gradient descent methods are used, the loss function is used to determine a gradient of the loss function with respect to the parameters of the neural network architecture, where the gradient is then used to back propagate an update to the parameter values of the neural network architecture. Typically, the update is propagated according to the derivative of the weights of the neural network layers. For example, a gradient of the loss function with respect to the weights of the neural network layers may be determined and used to determine an update to the weights that minimizes the loss function. In this case, optimization techniques such as gradient descent, stochastic gradient descent, Adam etc. may be used to adjust the weights. The chain rule and auto-differentiation functions may be applied to efficiently compute the gradient of the loss function, working back through the neural network layers in turn.

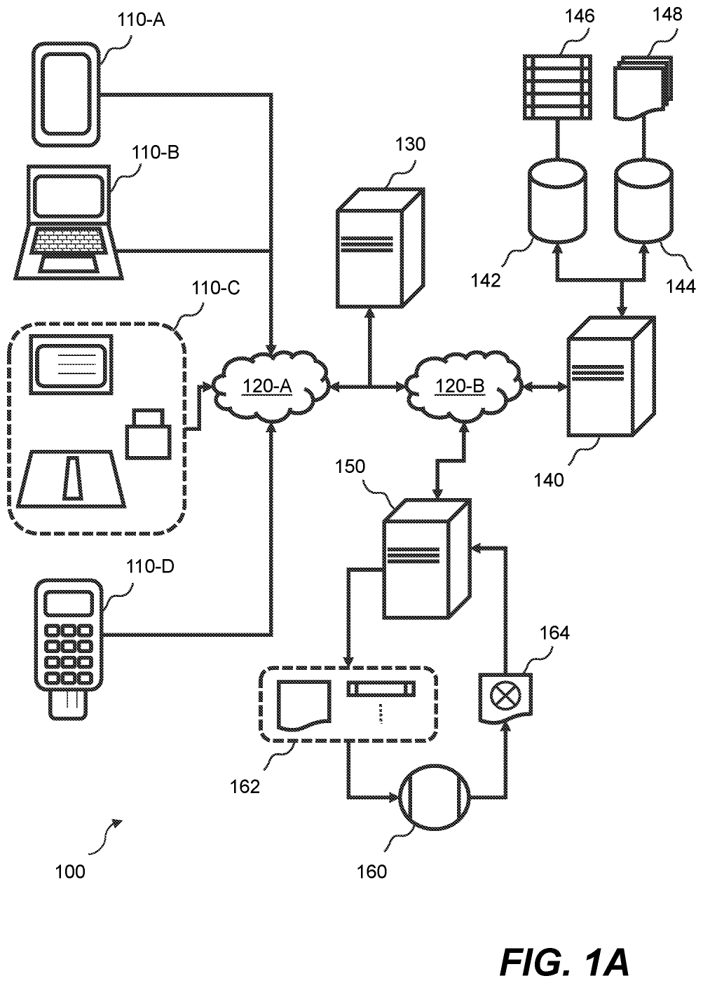

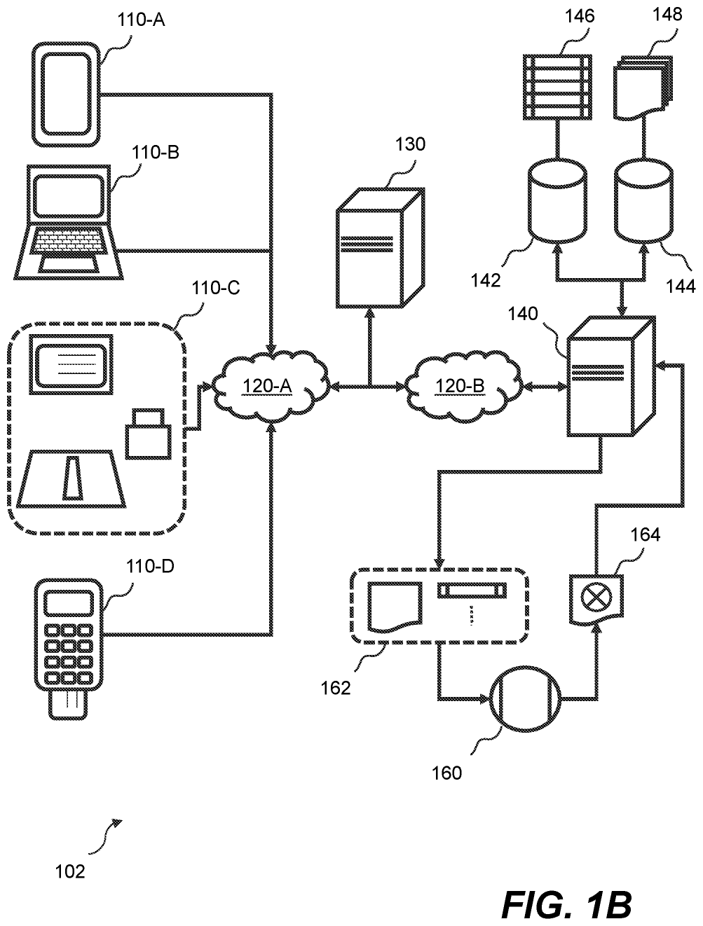

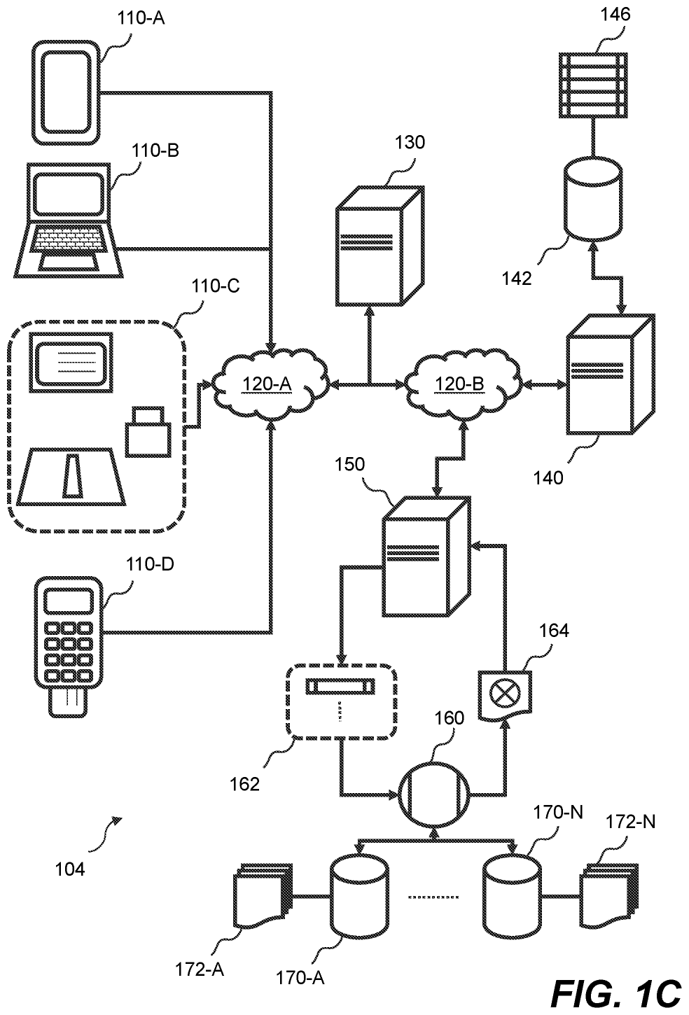

A non-limiting exemplary embodiment of a machine learning system in accordance with an embodiment of the invention is described below. FIGS. 1A to 5B provide context for the machine learning system.

### Overview

According to a first aspect, there is provided a method of controlling access to machine learning model data in a multi-tenant machine learning system having a machine learning model data access hierarchy, the machine learning model data access hierarchy comprising:
a tenant level comprising first and second tenants associated with first and second tenant machine learning model data respectively; and
a tenant group level comprising a tenant group to which the first and second tenants belong, wherein the tenant group is associated with tenant group machine learning model data, and wherein the tenant group machine learning model data is based on the first and/or second tenant machine learning model data,
the method comprising, for a machine learning model being applied in respect of the first tenant at the tenant group level:
   allowing access to the tenant group machine learning model data and the first tenant machine learning model data; and
   inhibiting access to the second tenant machine learning model data.

The multi-tenant machine learning system enables a single system supporting multiple tenants to be deployed. This can greatly improve deployment and maintenance efficiency compared to separate installs for separate tenants and/or separate types of data.

The machine learning model data access hierarchy provides a computationally efficient mechanism to segregate the first and second tenant machine learning model data (for example in terms of direct tenant access) within a single system compared, again, to having separate installs for separate tenants for example. Segregation may be especially effective for machine learning model data. Additionally, computational efficiency gains are effective in the context of machine learning where relatively large amounts of machine learning model data may be used.

The tenant group machine learning model data may be based on the first and second tenant machine learning model data, for example if the first and second tenants have been in the tenant group for an extended period of time.

Alternatively, the tenant group machine learning model data might only be based on one of the first and second tenant machine learning model data, for example if one of the first and second tenants has recently joined the tenant group.

In either case, the tenant group machine learning model data provides abstracted data with respect to the first and second tenant machine learning model data, which may be used for abstracted analytics for example.

In some examples, the tenant group machine learning model data is based on the first tenant machine learning model data; and the tenant group machine learning model data is not based on the second tenant machine learning model data or is based on a restricted version of the second tenant machine learning model data.

In some examples, the second tenant joined the tenant group after the first tenant joined the tenant group.

In such examples, the second tenant machine learning model data makes no or minimal contribution to the tenant group machine learning model data. This may be especially effective where the second tenant has recently joined the tenant group, for example from another tenant group. The contribution of the second tenant machine learning model data to the tenant group machine learning model data can be lower than the first tenant machine learning model data to the tenant group machine learning model data, consistent with the amount of time the first and second tenants have belonged to the tenant group. In some cases, the longer a given tenant belongs to a given tenant group, the stronger the match in characteristics between the given tenant and the given tenant group and, as such, the greater the influence of given tenant machine learning model data associated with the given tenant on given tenant group machine learning model data associated with the given tenant group.

In some examples, the tenant group machine learning model data is based on at least a historic set of the first tenant machine learning model data; and the tenant group machine learning model data is not based on at least a historic set of the second tenant machine learning model data or is based on a restricted version of the historic set of the second tenant machine learning model data.

In some examples, the historic set of the second tenant machine learning model data was generated before the second tenant joined the tenant group.

In such examples, the historic set of the second tenant machine learning model data may be less representative of a current state associated with the second tenant than a recent set of second tenant machine learning model data. The contribution of the less representative, historic second tenant machine learning model data on the tenant group machine learning model data can thereby be limited. This, in turn, can result in more accurate tenant group machine learning model data.

In some examples, the tenant group machine learning model data is updated to produce updated tenant group machine learning model data and the updated tenant group machine learning model data is based on both the first and second tenant machine learning model data.

In such examples, the influence of the second tenant machine learning model data on the tenant group machine learning model data may be increased, for example over time while the second tenant remains part of the tenant group. Such contribution may be non-restricted.

In some examples, the tenant group machine learning model data is based on at least some of each of the first and second machine learning model data.

As such, the tenant group machine learning model data is based on both the first and second machine learning model data, at least to some degree. This may be especially effective where the first and second tenants have been in the tenant group for an extended period of time.

In some examples, the tenant group machine learning model data is derived based on one or more operations involving said at least some of each of the first and second machine learning model data.

In such examples, a degree of combination and/or aggregation can be performed, giving a higher-level abstraction of the first and second machine learning model data. This may, for example, facilitate a higher-level analysis of the first and second machine learning model data.

In some examples, the method comprises, for a machine learning model being applied in respect of the second tenant at the tenant group level: allowing access to the tenant group machine learning model data and the second tenant machine learning model data; and inhibiting access to the first tenant machine learning model data.

In such examples, the first and second tenants may benefit from the machine learning model application described herein while strong data segregation and isolation is maintained as between the first and second tenants.

In some examples, the method comprises, for a machine learning model being applied in respect of the first and/or second tenant at the tenant level, inhibiting access to the tenant group machine learning model data.

In such examples, the access control can prevent the model at the tenant level from accessing the tenant group machine learning model data. This can enhance data segregation as between the first and second tenants.

In some examples, the method comprises, for a machine learning model being applied in respect of the first and/or second tenant at the tenant level, selectively allowing access to the tenant group machine learning model data based on one or more permission settings being enabled for the machine learning model being applied in respect of the first and/or second tenant at the tenant level.

In such examples, access can be selectively enabled to the tenant group machine learning model data, for example by enabling the relevant permissions. This may improve anomaly detection, for example by having a more holistic view of behaviour in the hierarchy.

In some examples, the machine learning model data access hierarchy comprises an administrator level at which a machine learning model is applicable in respect of the first tenant, the administrator level comprises an administrator associated with administrator machine learning model data, and the tenant group belongs to the administrator.

In some examples, the method comprises, for the machine learning model being applied in respect of the first tenant at the administrator level: allowing access to the administrator machine learning model data, the tenant group machine learning model data and the first tenant machine learning model data; and inhibiting access to the second tenant machine learning model data.

In some examples, a further level of control, analysis and/or hierarchy may be provided.

In some examples, the tenant group level comprises a further tenant group to which at least one further tenant belongs and to which the first and second tenants do not belong, the further tenant group belongs to the administrator, the further tenant group is associated with further tenant group machine learning model data, and the at least one further tenant is associated with further tenant machine learning model data.

In such examples, different abstractions in the form of tenant groups may be available in the hierarchy. The different abstractions may be associated with different tenant group characteristics and/or different tenant characteristics.

In some examples, the method comprises, for the machine learning model being applied in respect of the first tenant at the tenant group level, inhibiting access to the further tenant group machine learning model data and/or the further tenant machine learning model data.

In some examples, the method comprises, for the machine learning model being applied in respect of the first tenant at the administrator level, inhibiting access to the further tenant group machine learning model data and/or the further tenant machine learning model data.

In such examples, a more flexible hierarchy is provided, while still providing strong data segregation.

In some examples, the machine learning model data access hierarchy comprises an additional tenant associated with additional tenant machine learning model data, and the additional tenant belongs to the administrator.

In such examples, the additional tenant may not exhibit strong matching characteristics with a tenant group and/or another tenant, and may belong directly to the administrator.

Requiring all tenants to belong to a tenant group may result in less accurate machine learning model data, in that a given additional tenant not exhibiting strong matching characteristics with a given tenant group may skew given tenant group machine learning model data associated with the given tenant group if the given tenant were to join the given tenant group.

In some examples, the method comprises, for the machine learning model being applied in respect of the first tenant at the tenant group level, inhibiting access to the additional tenant machine learning model data.

In some examples, the method comprises, for the machine learning mode being applied in respect of the first tenant at the administrator level, inhibiting access to the additional tenant machine learning model data.

In such examples, a more flexible hierarchy is provided, while still providing strong data segregation.

In some examples, the method comprises performing a predetermined action in relation to the tenant group machine learning model data in response to the first and/or second tenant no longer belonging to the tenant group.

In such examples, a predetermined action may be taken when the first and/or second tenant leaves the tenant group. For example, the machine learning model data associated with the leaving tenant may be removed immediately or reduced immediately or over time.

In some examples, the machine learning model data comprises machine learning model state data and/or machine learning model parameter data.

In such examples, the machine learning model data access hierarchy provides especially effective access control to machine learning data where, generally, large amounts of data are present. Efficient resource usage in such contexts can be especially effective.

In some examples, the tenant group machine learning model data and/or the first tenant machine learning model data is used to perform real-time anomaly detection associated with the first tenant.

In such examples, involving real-time detection, the efficiencies provided by the machine learning model data access hierarchy are especially effective.

According to a second aspect, there is provided a method of controlling access to learning model data in a multi-tenant system having a learning model data access hierarchy, the learning model data access hierarchy comprising:
a tenant level comprising first and second tenants associated with first and second tenant learning model data respectively; and
a tenant group level comprising a tenant group to which at least the first tenant belongs, wherein the tenant group is associated with tenant group learning model data, and wherein the tenant group learning model data is based at least on the first tenant learning model data,
the method comprising, for a learning model being applied in respect of the first tenant at the tenant group level and/or for a learning model being applied in respect of the first tenant at the tenant level:
   allowing access to the tenant group learning model data and the first tenant learning model data; and
   inhibiting access to the second tenant learning model data.

As such, even greater applicability, functionality and efficiencies may be provided with respect to other example methods, systems and hierarchies described herein.

The learning model may comprise a machine learning model and/or another type of learning model as described herein.

According to a third aspect, there is provided a method of controlling access to machine learning model data in a multi-tenant machine learning system having a machine learning model data access hierarchy, the machine learning model data access hierarchy comprising:
a first tenant associated with first tenant machine learning model data;
a second tenant associated with second tenant machine learning model data; and
a tenant group associated with tenant group machine learning model data,
the method comprising controlling access to machine learning model data such that:
   at a first time:
      the first tenant belongs to the tenant group and the second tenant does not belong to the tenant group; and
      the tenant group machine learning model data is based on the first tenant machine learning model data and the tenant group machine learning model data is not based on the second tenant machine learning model data;
   at a second, later time:
      the first and second tenant belong to the tenant group; and
      the tenant group machine learning model data is based at least on the first tenant machine learning model data; and
   at a third, later time:
      the tenant group machine learning model data is based on the first and second tenant machine learning model data.

As such, delayed or staggered use of tenant machine learning model data may be provided. This may enable accurate tenant group machine learning model data dependent on characteristics of different tenants at different times.

According to a fourth aspect, there is provided a multi-tenant machine learning system configured to perform a method provided according to the first, second and/or third embodiments.

According to a fifth aspect, there is provided a multi-tenant machine learning system having access to a machine learning model data access hierarchy comprising multiple tenants and one or more tenant groups, the multi-tenant machine learning system comprising a machine learning model data access controller configured to control access to machine learning model data in accordance with the machine learning model data access hierarchy.

### Example Transaction Processing System

A non-limiting exemplary embodiment of a machine learning system in accordance with an embodiment of the invention is described below. FIGS. 1A to 5B provide context for the machine learning system.

FIGS. 1A to 1C show a set of example transaction processing systems 100, 102, 104. These example transaction processing systems are described to provide context for the inventions discussed herein but should not be seen as limiting; the configuration of any one implementation may differ based on the specific requirements of that implementation. However, the described example transaction processing systems allow those skilled in the art to identify certain high-level technical features that are relevant for the description below. The three example transaction processing systems 100, 102, 104 show different areas where variation may occur.

FIGS. 1A to 1C show a set of client devices 110 that are configured to initiate a transaction. In this example, the set of client devices 110 comprise a smartphone 110-A, a computer 110-B, a point-of-sale (POS) system 110-C and a portable merchant device 110-D. These client devices 110 provide a set of non-exhaustive examples. Generally, any electronic device or set of devices may be used to undertake a transaction. In one case, the transaction comprises a purchase or payment. For example, the purchase or payment may be an online or mobile purchase or payment made by way of the smartphone 110-A or the computer 110-B, or may be a purchase or payment made at a merchant premises, such as via the POS system 110-C or the portable merchant device 110-D. The purchase or payment may be for goods and/or services.

In FIGS. 1A to 1C, the client devices 110 are communicatively coupled to one or more computer networks 120. The client devices 110 may be communicatively coupled in a variety of ways, including by one or more wired and/or wireless networks including telecommunications networks. In preferred examples, all communications across the one or more computer networks are secured, e.g. using Transport Layer Security (TLS) protocols. In FIG. 1A, two computer networks are shown 120-A and 120-B. These may be separate networks or different portions of a common network. The first computer network 120-A communicatively couples the client devices 110 to a merchant server 130. The merchant server 130 may execute a computer process that implements a process flow for the transaction. For example, the merchant server 130 may be a back-end server that handles transaction requests received from the POS system 110-C or the portable merchant device 110-D or may be used by an online merchant to implement a website where purchases may be made. It will be appreciated that the examples of FIGS. 1A to 1C are necessary simplifications of actual architectures; for example, there may be several interacting server devices that implement an online merchant, including separate server devices for providing HyperText Markup Language (HTML) pages detailing a product and/or service and for handling a payment process.

In FIG. 1A, the merchant server 130 is communicatively coupled to a further set of back-end server devices to process the transaction. In FIG. 1A, the merchant server 130 is communicatively coupled to a payment processor server 140 via a second network 120-B. The payment processor server 140 is communicatively coupled to a first data storage device 142 storing transaction data 146 and a second data storage device 144 storing ancillary data 148. The transaction data 146 may comprise batches of transaction data relating to different transactions that are undertaken over a period of time. The ancillary data 148 may comprise data associated with the transactions, such as records storing merchant and/or end user data. In FIG. 1A, the payment processor server 140 is communicatively coupled to a machine learning server 150 via the second network 120-B.

The machine learning server 150 implements a machine learning system 160 for the processing of transaction data. The machine learning system 160 is arranged to receive input data 162 and to map this to output data 164 that is used by the payment processor server 140 to process a particular transaction, such as one arising from the client devices 110. In one case, the machine learning system 160 receives at least transaction data associated with the particular transaction and provides an alert or numeric output that is used by the payment processor server 140 to determine whether the transaction is to be authorised (i.e., approved) or declined. As such, the output of the machine learning system 160 may comprise a label, alert or other indication of fraud, or general malicious or anomalous activity. The output may comprise a probabilistic indication, such as a score or probability. In one case, the output data 164 may comprise a scalar numeric value. The input data 162 may further comprise data derived from one or more of the transaction data 146 and the ancillary data 148. In one case, the output data 164 indicates a level of deviation from a specific expected pattern of behaviour based on past observations or measurements. For example, this may indicate fraud or criminal behaviour as this often differs significantly from observed patterns of behaviour, especially on a large scale. The output data 164 may form a behavioural measure. The expected pattern of behaviour may be defined, either explicitly or implicitly, based on observed interactions between different entities within the transaction process flow, such as end users or customers, merchants (including point-of-sale and back-end locations or entities where these may differ), and banks.

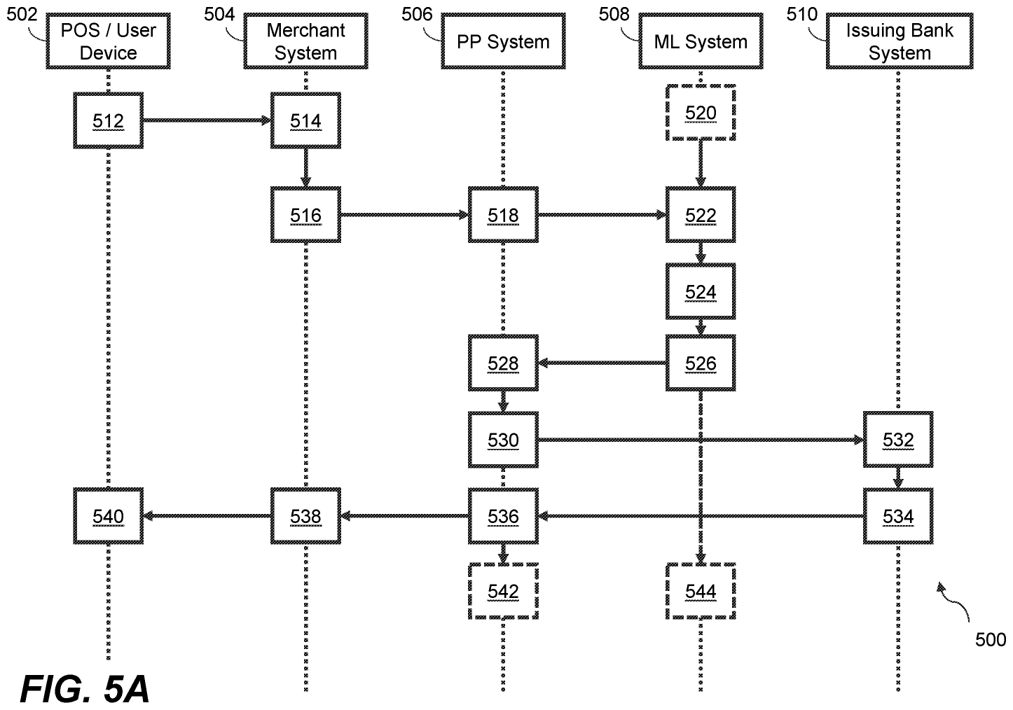

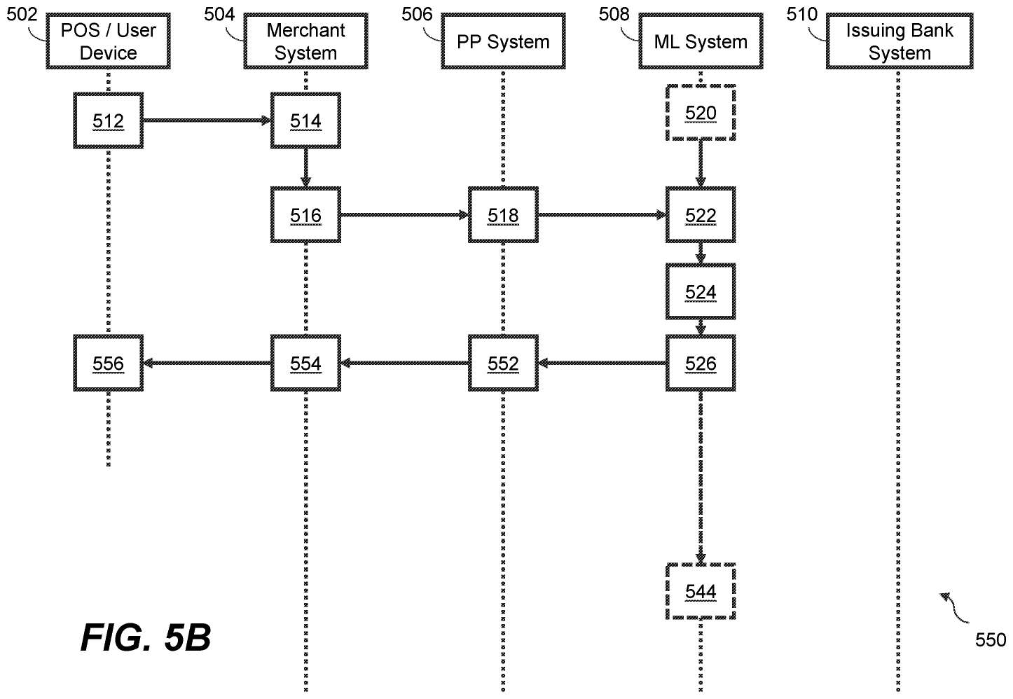

The machine learning system 160 may be implemented as part of a transaction processing pipeline. An example transaction processing pipeline is described later with respect to FIGS. 5A and 5B. A transaction processing pipeline may comprise electronic communications between the client devices 110, merchant server 130, payment processor server 140 and machine learning server 150. Other server devices may also be involved, such as banking servers that provide authorisation from an issuing bank. In certain cases, client devices 110 may directly communicate with the payment processor server 140. In use, a transaction processing pipeline typically needs to be completed within one or two hundred milliseconds. In general, sub-second processing times may be deemed real-time (e.g., human beings typically perceive events on a timespan of 400 ms). Furthermore, 100-200 ms may be the desired maximum latency of the full round-trip-time for transaction processing; within this timespan, the time allotted for the machine learning system 160 may be a small fraction of this full amount, such as 10 ms (i.e., less that 5-10% of the target processing time), as most of the time may be reserved for other operations in the transaction processing flow. This presents a technical constraint for the implementation of the machine learning system 160. Furthermore, in real-world implementations, average processing volumes may be on the order of 1000-2000 a second. This means that most “off-the-shelf” machine learning systems are not suitable to implement machine learning system 160. It further means that most machine learning approaches described in academic papers cannot be implemented within the aforementioned transaction processing pipeline without non-obvious adaptations. There is also a problem that anomalies are, by their very nature, rare events and so accurate machine learning systems are difficult to train.

FIG. 1B shows a variation 102 of the example transaction processing system 100 of FIG. 1A. In this variation 102, the machine learning system 160 is implemented within the payment processor computer infrastructure, e.g. executed by the payment processor server 140 and/or executed on a locally coupled server within the same local network as the payment processor server 140. The variation 102 of FIG. 1B may be preferred for larger payment processors as it allows faster response times, greater control, and improved security. However, functionally, the transaction processing pipeline may be similar to that of FIG. 1A. For example, in the example of FIG. 1A, the machine learning system 160 may be initiated by a secure external application programming interface (API) call, such as a

Representation State Transfer (REST) API call using Hypertext Transfer Protocol Secure (HTTPS), while in FIG. 1B, the machine learning system 160 may be initiated by an internal API call, but where a common end API may handle both requests (e.g., the REST HTTPS API may provide an external wrapper for the internal API).

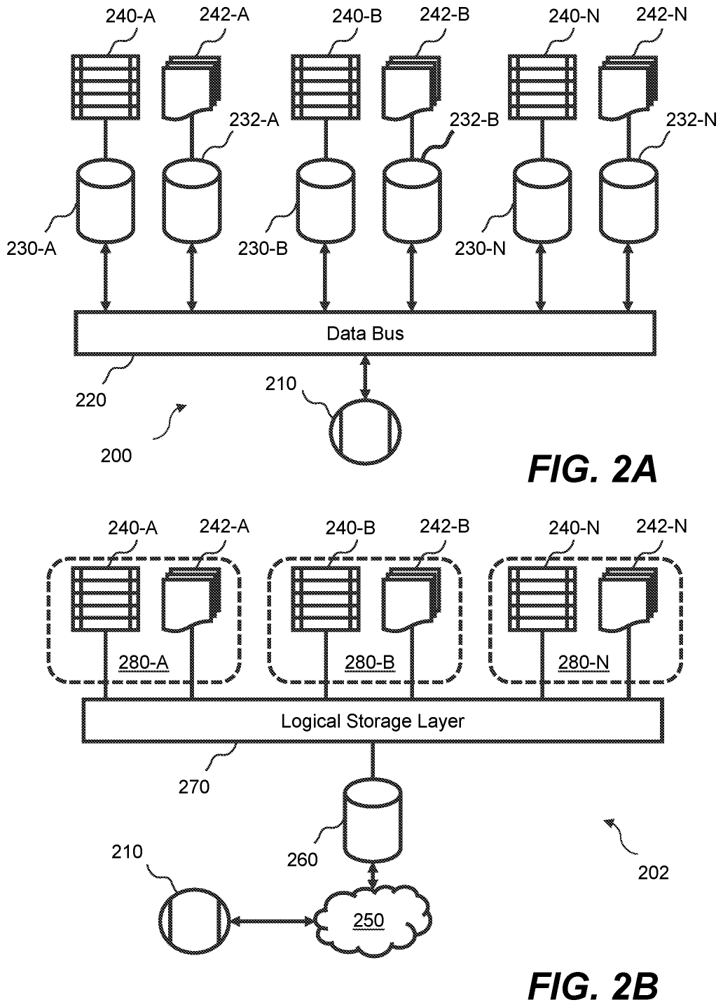

FIG. 1C shows another variation 104 of the example transaction processing system 100 of FIG. 1A. In this variation 104, the machine learning system 160 is communicatively coupled to local data storage devices 170. For example, data storage devices 170 may be on the same local network as machine learning server 150 or may comprise a local storage network accessible to the machine learning server 150. In this case, there are a plurality of local data storage devices 170-A to 170-N, where each data storage device stores partitioned ancillary data 172. The partitioned ancillary data 172 may comprise parameters for one or more machine learning models. In one case, the ancillary data 172 may comprise a state for machine learning models, where the state may relate to a specific entity such as a user or merchant. The partitioning of the ancillary data 172 may need to be applied to meet security requirements set by a third party, such as the payment processor, one or more banks and/or one or more merchants. In use, the machine learning system 160 accesses the ancillary data 172-A to 172-N via the plurality of local data storage devices 170-A to 170-N based on the input data 162. For example, the input data 162 may be received by way of an API request from a particular source and/or may comprise data that identifies that a particular partition is to be used to handle the API request. More details of different storage systems that may be applied to meet security requirements are set out in FIGS. 2A and 2B.

### Example Data Storage Configurations

FIGS. 2A and 2B show two example data storage configurations 200 and 202 that may be used by an example machine learning system 210 for the processing of transaction data. The examples of FIGS. 2A and 2B are two non-limiting examples that show different options available for implementations, and particular configurations may be selected according to individual circumstances. The machine learning system 210 may comprise an implementation of the machine learning system 160 described in the previous examples of FIGS. 1A to 1C. The examples of FIGS. 2A and 2B allow for the processing of transaction data that is secured using heterogeneous cryptographic parameters, e.g. for the machine learning system 210 to securely process transaction data for heterogeneous entities. It will be appreciated that the configurations of FIGS. 2A and 2B may not be used if the machine learning system 160 is implemented for a single set of secure transaction and ancillary data, e.g. within an internal transaction processing system or as a hosted system for use by a single payment processor.

FIG. 2A shows a machine learning system 210 communicatively coupled to a data bus 220. The data bus 220 may comprise an internal data bus of the machine learning server 150 or may form part of storage area network. The data bus 220 communicatively couples the machine learning system 210 to a plurality of data storage devices 230, 232. The data storage devices 230, 232 may comprise any known data storage device such as magnetic hard disks and solid-state devices. Although data storage devices 230, 232 are shown as different devices in FIG. 2A they may alternatively form different physical areas or portions of storage within a common data storage device. In FIG. 2A, the plurality of data storage devices 230, 232 store historical transaction data 240 and ancillary data 242. In FIG. 2A, a first set of data storage devices 230 store historical transaction data 240 and a second set of data storage devices 232 store ancillary data 242. Ancillary data 242 may comprise one or more of model parameters for a set of machine learning models (such as trained parameters for a neural network architecture and/or configuration parameters for a random forest model) and state data for those models. In one case, the different sets of historical transaction data 240-A to N and ancillary data 242-A to N are associated with different entities that securely and collectively use services provided by the machine learning system 210, e.g. these may represent data for different banks that need to be kept separate as part of the conditions of providing machine learning services to those entities.

FIG. 2B shows another way different sets of historical transaction data 240-A to N and ancillary data 242-A to N may be stored. In FIG. 2B the machine learning system 210 is communicatively coupled, via data transfer channel 250, to at least one data storage device 260. The data transfer channel 250 may comprise a local storage bus, local storage area network, and/or remote secure storage coupling (e.g., as overlaid over insecure networks such as the Internet). In FIG. 2B, a secure logical storage layer 270 is provided using the physical data storage device 260. The secure logical storage layer 270 may be a virtualized system that appears as separate physical storage devices to the machine learning system 210 while actually being implemented independently upon the at least one data storage device 260. The logical storage layer 270 may provide separate encrypted partitions 280 for data relating to groups of entities (e.g., relating to different issuing banks etc.) and the different sets of historical transaction data 240-A to N and ancillary data 242-A to N may be stored in the corresponding partitions 280-A to N. In certain cases, entities may be dynamically created as transactions are received for processing based on data stored by one or more of the server systems shown in FIGS. 1A to 1C.

### Example Transaction Data

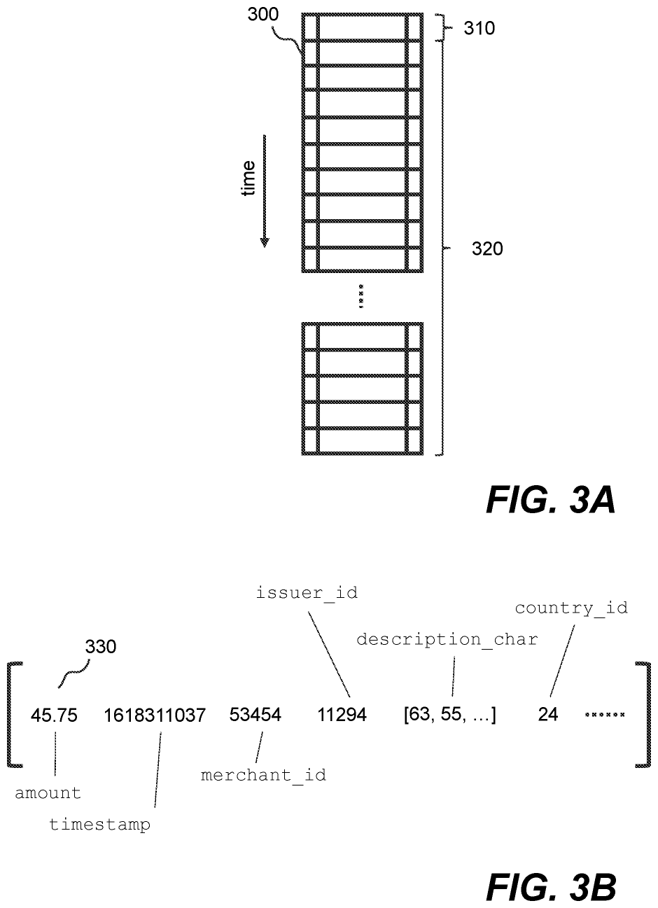

FIGS. 3A and 3B show examples of transaction data that may be processed by a machine learning system such as 160 or 210. FIG. 3A shows how transaction data may comprise a set of time-ordered records 300, where each record has a timestamp and comprises a plurality of transaction fields. In certain cases, transaction data may be grouped and/or filtered based on the timestamp. For example, FIG. 3A shows a partition of transaction data into current transaction data 310 that is associated with a current transaction and “older” or historical transaction data 320 that is within a predefined time range of the current transaction. The time range may be set as a hyperparameter of any machine learning system. Alternatively, the “older” or historical transaction data 320 may be set as a certain number of transactions. Mixtures of the two approaches are also possible.

FIG. 3B shows how transaction data 330 for a particular transaction may be stored in numeric form for processing by one or more machine learning models. For example, in FIG. 3B, transaction data has at least fields: transaction amount, timestamp (e.g., as a Unix epoch), transaction type (e.g., card payment or direct debit), product description or identifier (i.e., relating to items being purchased), merchant identifier, issuing bank identifier, a set of characters (e.g., Unicode characters within a field of predefined character length), country identifier etc. It should be noted that a wide variety of data types and formats may be received and pre-processed into appropriate numerical representations. In certain cases, originating transaction data, such as that generated by a client device and sent to merchant server 130 is pre-processed to convert alphanumeric data types to numeric data types for the application of the one or more machine learning models. Other fields present in the transaction data can include, but are not limited to, an account number (e.g., a credit card number), a location of where the transaction is occurring, and a manner (e.g., in person, over the phone, on a website) in which the transaction is executed.

### Example Machine Learning System

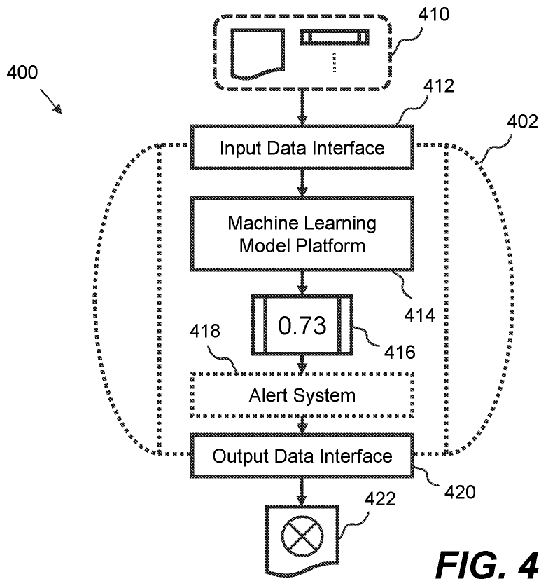

FIG. 4 shows one example 400 of a machine learning system 402 that may be used to process transaction data. Machine learning system 402 may implement one or more of machine learning systems 160 and 210. The machine learning system 402 receives input data 410. The form of the input data 410 may depend on which machine learning model is being applied by the machine learning system 402. In a case where the machine learning system 402 is configured to perform fraud or anomaly detection in relation to a transaction, e.g. a transaction in progress as described above, the input data 410 may comprise transaction data such as 330 (i.e., data forming part of a data package for the transaction) as well as data derived from historical transaction data (such as 300 in FIG. 3A) and/or data derived from ancillary data (such as 148 in FIGS. 1A to 1C or 242 in FIGS. 2A and 2B). The ancillary data may comprise secondary data linked to one or more entities identified in the primary data associated with the transaction. For example, if transaction data for a transaction in progress identifies a user, merchant and one or more banks associated with the transaction (such as an issuing bank for the user and a merchant bank), such as via unique identifiers present in the transaction data, then the ancillary data may comprise data relating to these transaction entities. The ancillary data may also comprise data derived from records of activity, such as interaction logs and/or authentication records. In one case, the ancillary data is stored in one or more static data records and is retrieved from these records based on the received transaction data. Additionally, or alternatively, the ancillary data may comprise machine learning model parameters that are retrieved based on the contents of the transaction data. For example, machine learning models may have parameters that are specific to one or more of the user, merchant and issuing bank, and these parameters may be retrieved based on which of these is identified in the transaction data. For example, one or more of users, merchants, and issuing banks may have corresponding embeddings, which may comprise retrievable or mappable tensor representations for said entities. For example, each user or merchant may have a tensor representation (e.g., a floating-point vector of size 128-1024) that may either be retrieved from a database or other data storage or may be generated by an embedding layer, e.g. based on a user or merchant index.

The input data 410 is received at an input data interface 412. The input data interface 412 may comprise an API interface, such as an internal or external API interface as described above.

In one case, the payment processor server 140 as shown in FIGS. 1A to 1C makes a request to this interface, where the request payload contains the transaction data. The API interface may be defined to be agnostic as to the form of the transaction data or its source. The input data interface 412 is communicatively coupled to a machine learning model platform 414. In one case, a request made to the input data interface 412 triggers the execution of the machine learning model platform 414 using the transaction data supplied to the interface. The machine learning model platform 414 is configured as an execution environment for the application of one or more machine learning models to the input data 410. In one case, the machine learning model platform 414 is arranged as an execution wrapper for a plurality of different selectable machine learning models. For example, a machine learning model may be defined using a model definition language (e.g., similar to, or using, markup languages such as extended Markup Language-XML). Model definition languages may include (amongst others, independently or in combination), SQL, TensorFlow, Caffe, Thinc and PyTorch. In one case, the model definition language comprises computer program code that is executable to implement one or more of training and inference of a defined machine learning model. The machine learning models may, for example, comprise, amongst others, artificial neural network architectures, ensemble models, regression models, decision trees such as random forests, graph models, and Bayesian networks. The machine learning model platform 414 may define common (i.e., shared) input and output definitions such that different machine learning models are applied in a common (i.e., shared) manner.

In the present example, the machine learning model platform 414 is configured to provide at least a single scalar output 416. This may be normalised within a predefined range, such as 0 to 1. When normalised, the scalar output 416 may be seen as a probability that a transaction associated with the input data 410 is fraudulent or anomalous. In this case, a value of “0” may represent a transaction that matches normal patterns of activity for one or more of a user, merchant and issuing bank, whereas a value of “1” may indicate that the transaction is fraudulent or anomalous, i.e. does not match expected patterns of activity (although those skilled in the art will be aware that the normalised range may differ, such as be inverted or within different bounds, and have the same functional effect). It should be noted that although a range of values may be defined as 0 to 1, output values may not be uniformly distributed within this range, for example, a value of “0.2” may be a common output for a “normal” event and a value of “0.8” may be seen as being over a threshold for a typical “anomalous” or fraudulent event. The machine learning model implemented by the machine learning platform 414 may thus implement a form of mapping between high-dimensionality input data (e.g., the transaction data and any retrieve ancillary data) and a single value output. In one case, for example, the machine learning platform 414 may be configured to receive input data for the machine learning model in a numeric format, wherein each defined machine learning model is configured to map input data defined in the same manner. The exact machine learning model that is applied by the machine learning model platform 414, and the parameters for that model, may be determined based on configuration data. The configuration data may be contained within, and/or identified using, the input data 410 and/or may be set based on one or more configuration files that are parsed by the machine learning platform 414.

In certain cases, the machine learning model platform 414 may provide additional outputs depending on the context. In certain implementations, the machine learning model platform 414 may be configured to return a “reason code” capturing a human-friendly explanation of a machine learning model's output in terms of suspicious input attributes. For example, the machine learning model platform 414 may indicate which of one or more input elements or units within an input representation influenced the model output, e.g. a combination of an “amount” channel being above a learnt threshold and a set of “merchant” elements or units (such as an embedding or index) being outside a given cluster. In cases, where the machine learning model platform 414 implements a decision tree, these additional outputs may comprise a route through the decision tree or an aggregate feature importance based on an ensemble of trees. For neural network architectures, this may comprise layer output activations and/or layer filters with positive activations.

In FIG. 4, certain implementations may comprise an optional alert system 418 that receives the scalar output 416. In other implementations, the scalar output 416 may be passed directly to an output data interface 420 without post processing. In this latter case, the scalar output 416 may be packaged into a response to an original request to the input data interface 412. In both cases, output data 422 derived from the scalar output 416 is provided as an output of the machine learning system 402. The output data 422 is returned to allow final processing of the transaction data. For example, the output data 422 may be returned to the payment processor server 140 and used as the basis of a decision to approve or decline the transaction. Depending on implementation requirements, in one case, the alert system 418 may process the scalar output 416 to return a binary value indicating whether the transaction should be approved or declined (e.g., “1” equals decline). In certain cases, a decision may be made by applying a threshold to the scalar output 416. This threshold may be context dependent. In certain cases, the alert system 418 and/or the output data interface 420 may also receive additional inputs, such as explanation data (e.g., the “reason code” discussed above) and/or the original input data. The output data interface 420 may generate an output data package for output data 422 that combines these inputs with the scalar output 416 (e.g., at least for logging and/or later review). Similar, an alert generated by the alert system 418 may include and/or be additionally based on the aforementioned additional inputs, e.g. in addition to the scalar output 416.

The machine learning system 402 is typically used in an “online” mode to process a high volume of transactions within a narrowly defined time range. For example, in normal processing conditions the machine learning system 402 may process requests within 7-12 ms and be able to manage 1000-2000 requests a second (these being median constraints from real-world operating conditions). However, the machine learning system 402 may also be used in an “offline” mode, e.g. by providing a selected historical transaction to the input data interface 412. In an offline mode, input data may be passed to the input data interfaces in batches (i.e., groups). The machine learning system 402 may also be able to implement machine learning models that provide a scalar output for an entity as well as, or instead of, a transaction. For example, the machine learning system 402 may receive a request associated with an identified user (e.g., a card or payment account holder) or an identified merchant and be arranged to provide a scalar output 416 indicating a likelihood that the user or merchant is fraudulent, malicious, or anomalous (i.e., a general threat or risk). For example, this may form part of a continuous or periodic monitoring process, or a one-off request (e.g., as part of an application for a service). The provision of a scalar output for a particular entity may be based on a set of transaction data up to and including a last approved transaction within a sequence of transaction data (e.g., transaction data for an entity similar to that should in FIG. 3A).

Both ‘live’ and ‘batch’ data may be received and used by the machine learning system. These may be received by the same set of EventAPIs with different REST endpoints, or a different set of EventAPIs dedicated to reading batch data from another source. Additionally or alternatively, EventAPIs may read events from another source (rather than receiving them via REST), e.g. by reading them from a comma-separated values (CSV) file or any other suitable file format.

### Example Transaction Process Flow

FIGS. 5A and 5B show two possible example transaction process flows 500 and 550. These process flows may take place in the context of the example transaction process systems 100, 102, 104 shown in FIGS. 1A to 1C as well as other systems. The process flows 500 and 550 are provided as one example of a context in which a machine learning transaction processing system may be applied, however not all transaction process flows will necessarily follow the processes shown in FIGS. 5A and 5B and process flows may change between implementations, systems and over time. The example transaction process flows 500 and 550 reflect two possible cases: a first case represented by transaction process flow 500 where a transaction is approved, and a second case represented by transaction process flow 550 where a transaction is declined. Each transaction process flow 500, 550 involves the same set of five interacting systems and devices: a POS or user device 502, a merchant system 504, a payment processor (PP) system 506, a machine learning (ML) system 508 and an issuing bank system 510. The POS or user device 502 may comprise one of the client devices 110, the merchant system 504 may comprise the merchant server 130, the payment processor system 506 may comprise the payment processor server 140, and the machine learning system 508 may comprise an implementation of the machine learning system 160, 210 and/or 402. The issuing bank system 510 may comprise one or more server devices implementing transaction functions on behalf of an issuing bank. The five interacting systems and devices 502 to 510 may be communicatively coupled by one or more internal or external communication channels, such as networks 120. In certain cases, certain ones of these systems may be combined, e.g. an issuing bank may also act as a payment processor and so systems 506 and 510 may be implemented with a common system. In other cases, a similar process flow may be performed specifically for a merchant (e.g., without involving a payment processor or issuing bank). In this case, the machine learning system 508 may communicate directly with the merchant system 504. In these variations, a general functional transaction process flow may remain similar to that described below.

The transaction process flow in both FIGS. 5A and 5B comprises a number of common (i.e., shared) processes 512 to 528. At block 512, the POS or user device 502 initiates a transaction. For a POS device, this may comprise a cashier using a front-end device to attempt to take an electronic payment; for a user device 502 this may comprise a user making an online purchase (e.g., clicking “complete” within an online basket) using a credit or debit card, or an online payment account. At block 514, the payment details are received as electronic data by the merchant system 504. At block 516, the transaction is processed by the merchant system 504 and a request is made to the payment processor system 506 to authorise the payment. At block 518, the payment processor system 506 receives the request from the merchant system 504. The request may be made over a proprietary communications channel or as a secure request over public networks (e.g., an HTTPS request over the Internet). The payment processor system 506 then makes a request to the machine learning system 508 for a score or probability for use in processing the transaction. Block 518 may additional comprise retrieving ancillary data to combine with the transaction data that is sent as part of the request to the machine learning system 508. In other cases, the machine learning system 508 may have access to data storage devices that store ancillary data (e.g., similar to the configurations of FIGS. 2A and 2B) and so retrieve this data as part of internal operations (e.g., based on identifiers provided within the transaction data and/or as defined as part of an implemented machine learning model).

Block 520 shows a model initialisation operation that occurs prior to any requests from the payment processor system 506. For example, the model initialisation operation may comprise loading a defined machine learning model and parameters that instantiate the defined machine learning model. At block 522, the machine learning system 508 receives the request from the payment processor system 506 (e.g., via a data input interface such as 412 in FIG. 4). At block 522, the machine learning system 508 may perform any defined pre-processing prior to application of the machine learning model initialised at block 520. For example, in the case that the transaction data still retains character data, such as a merchant identified by a character string or a character transaction description, this may be converted into suitable structured numeric data (e.g., by converting string categorical data to an identifier via a look-up operation or other mapping, and/or by mapping characters or groups of characters to vector embeddings). Then at block 524 the machine learning system 506 applies the instantiated machine learning model, supplying the model with input data derived from the received request. This may comprise applying the machine learning model platform 414 as described with reference to FIG. 4. At block 526, a scalar output is generated by the instantiated machine learning model. This may be processed to determine an “approve” or “decline” binary decision at the machine learning system 508 or, in a preferred case, is returned to the payment processor system 506 as a response to the request made at block 518.

At block 528, the output of the machine learning system 508 is received by the payment processor system 506 and is used to approve or decline the transaction. FIG. 5A shows a process where the transaction is approved based on the output of the machine learning system 508; FIG. 5B shows a process where the transaction is declined based on the output of the machine learning system 508. In FIG. 5A, at block 528, the transaction is approved. Then at block 530, a request is made to the issuing bank system 532. At block 534, the issuing bank system 532 approves or declines the request. For example, the issuing bank system 532 may approve the request if an end user or card holder has sufficient funds and approval to cover the transaction cost. In certain cases, the issuing bank system 532 may apply a second level of security; however, this may not be required if the issuing bank relies on the anomaly detection performed by the payment processor using the machine learning system 508. At block 536, the authorisation from the issuing bank system 510 is returned to the payment processor system 506, which in turn sends a response to the merchant system 504 at block 538, and the merchant system 504 in turn responds to the POS or user device 502 at block 540. If the issuing bank system 510 approves the transaction at block 534, then the transaction may be completed, and a positive response returned via the merchant system 504 to the POS or user device 502. The end user may experience this as an “authorised” message on screen of the POS or user device 502. The merchant system 504 may then complete the purchase (e.g., initiate internal processing to fulfil the purchase).

At a later point in time, one or more of the merchant system 504 and the machine learning system 508 may save data relating to the transaction, e.g. as part of transaction data 146, 240 or 300 in the previous examples. This is shown at dashed blocks 542 and 544.

The transaction data may be saved along with one or more of the output of the machine learning system 508 (e.g., the scalar fraud or anomaly probability) and a final result of the transaction (e.g., whether it was approved or declined). The saved data may be stored for use as training data for the machine learning models implemented by the machine learning system 508.

The saved data may also be accessed as part of future iterations of block 524, e.g. may form part of future ancillary data. In certain cases, a final result or outcome of the transaction may not be known at the time of the transaction. For example, a transaction may only be labelled as anomalous via later review by an analyst and/or automated system, or based on feedback from a user (e.g., when the user reports fraud or indicates that a payment card or account was compromised from a certain date). In these cases, ground truth labels for the purposes of training the machine learning system 508 may be collected over time following the transaction itself.

Turning now to the alternative process flow of FIG. 5B, in this case one or more of the machine learning system 508 and the payment processor system 506 declines the transaction based on the output of the machine learning system 508. For example, a transaction may be declined if the scalar output of the machine learning system 508 is above a retrieved threshold. At block 552, the payment processor system 506 issues a response to the merchant system 504, which is received at block 554. At block 554, the merchant system 504 undertakes steps to prevent the transaction from completing and returns an appropriate response to the POS or user device 502. This response is received at block 556 and an end user or customer may be informed that their payment has been declined, e.g. via a “Declined” message on screen. The end user or customer may be prompted to use a different payment method. Although not shown in FIG. 5B, in certain cases, the issuing bank system 510 may be informed that a transaction relating to a particular account holder has been declined. The issuing bank system 510 may be informed as part of the process shown in FIG. 5B or may be informed as part of a periodic (e.g., daily) update. Although, the transaction may not become part of transaction data 146, 240 or 300 (as it was not approved), it may still be logged by at least the machine learning system 508 as indicated by block 544. For example, as for FIG. 5A, the transaction data may be saved along with the output of the machine learning system 508 (e.g., the scalar fraud or anomaly probability) and a final result of the transaction (e.g., that it was declined).

### Multi-Tenant Processing—Technical Effects

As explained above, having separate installs for different tenants and/or types of data running on the same software, while appearing as one system, can lead to complicated final solutions.

Examples described herein concern a different type of multi-tenant solution. A “tenant” may be a customer of an administrator of a platform. An administrator may be referred to as a “landlord”. The term “multi-tenant” is used herein to mean at least two tenants. Example multi-tenant solutions described herein may service every tenant of an administrator securely, with data segregation between different tenants.

Without loss of generality, examples described herein provide a single platform which segregates data by tenant. A given tenant may be identified in events by a ‘tenant ID’.

Tenants may be configured to be part of a hierarchy of containing Analytical Configuration Groups (ACG). ACGs are generally referred to herein as “tenant groups”. A tenant group comprises one or more than one tenant.

Tenant groups can themselves be contained in different Solutions. As such, a Solution may be considered to be a collection of one or more tenant groups.

Solutions can be structured in various different ways.

A user interface (UI) may be used to configure where in the hierarchy each tenant is located.

Data may be segregated, for example by tenant and tenant group. Each tenant and each tenant group may have its own area of a database in which models running in respect of tenants and tenant groups can store data.

When an event (for example, a transaction event) is processed, data is loaded from the database and is made available to one or models. Depending on access control rights, the data available to the model(s) may comprise: (i) data for that tenant, (ii) data for each tenant group that tenant is in, (iii) data for the containing Solution (if any), and/or (iv) platform-wide, administrator-level data.

The models can then decide how they want to process the data. If a model is a consortium model, created by the administrator to run across all events, then the model may consider an event as a whole, potentially using and storing data at each level in the hierarchy, appropriate to what that specific tenant group represents. If a model is only configured to run at a particular tenant group level or tenant level, then the model may only use data in that tenant group and below.

Example systems described herein allow for data to be used in both hierarchical directions (i.e., upwards and downwards) in a configuration hierarchy. Rules at the tenant group or administrator level may use data and events from all levels below them. Tenants and tenant groups may be able to use data that has been exposed to them by levels higher up in the hierarchy in their own rules. The data sharing rules, learnings, and data to be applied within business units, client sets, and other entities to adapt to changing events and circumstances quicker and more efficiently than existing systems, and without manual intervention. This general-purpose data sharing and hierarchical referencing is new in the world of machine learning platforms, particularly in fraud and risk.

Because the whole platform is a single system, the tenant hierarchy can be modified on the fly. A new Solution and/or tenant may readily be added to the existing platform, without having to deploy a new instance of the platform to run, for example, the new Solution. Models can either run within a given Solution, or can run across all Solutions. Data can be accessed up and down the hierarchy for each tenant.

Within the UI, each tenant and/or Solution can be configured to only allow access to that tenant, or to that Solution and all tenant groups below it. In examples, only the administrator has access to the system as a whole, and can take control of any tenant and/or tenant group on the platform to modify its analytics as required.

The example platforms described herein provide a high level of fine-grained control, allowing models to be segregated by Solution, tenant group and/or tenant, or to have access to the entire system as a consortium model.

The example platforms described herein simplify deployment, as the platform is deployed and configured once. Each Solution runs within the same platform, with data segregation managed by the platform and the models.

The example platforms described herein are also highly flexible, with analytical configuration and data segregated however best fits a specific use case. This architecture allows for differentiated and even overlapping analysis to be performed to increase adaptability and flexibility among tenant groups and hierarchies.

Examples described herein enable several individual instances to be provisioned from one multi-tenant configuration, offering immediate access to cutting-edge fraud and financial crime prevention technology; all while maintaining access control and accessibility to various combinations of functionality. In addition, with a multi-tenant architecture, a provider may run updates only once to distribute upgrades across all tenants.

In principle, the computational overhead of a single, multi-tenant platform may be very large, compared to individual instances for each tenant. There may also, in principle, be a risk of data ‘contamination’ in a single, multi-tenant platform. However, examples described herein provide a computationally efficient and data-segregated multi-tenant platform that is readily deployable, updatable, can be used for real-time anomaly detection, and to which configuration changes (such as adding new tenants) can be made efficiently and effectively.

### Multi-Tenant Processing—Machine Learning Model Data Access Hierarchy—Example 1

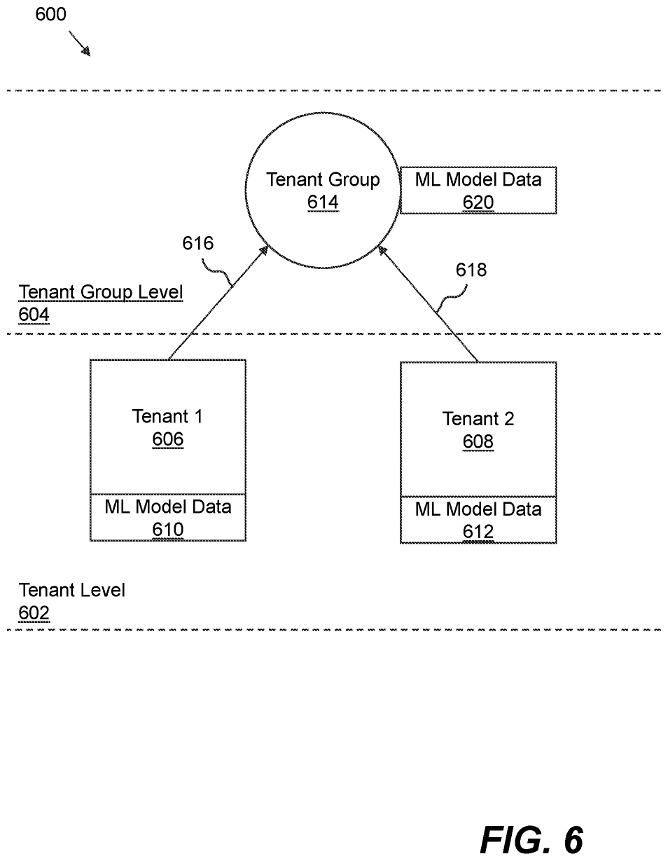

FIG. 6 shows an example machine learning model data access hierarchy 600. For convenience and brevity, a machine learning model data access hierarchy will generally be referred to herein as a “hierarchy”.

In this example, the hierarchy 600 comprises first and second levels 602, 604.

A “level” may be considered to be a logical association of a set of elements of the hierarchy 600. The association may be based at least in part on one or more characteristics of the elements in question. Although, in FIG. 6, elements belonging to the same level as each other are depicted as being in the same horizontal region of the hierarchy 600, this is solely to facilitate an understanding of the present disclosure. A level may also be referred to as a “layer”, or the like.

In this example, the first level 602 comprises a tenant level 602. In this example, the tenant level 602 comprises any and all tenants. In this specific example, the tenant level 602 comprises first and second tenants 606, 608.

The first and second tenants 606, 608 are associated with first and second tenant machine learning model data 610, 612 respectively. For convenience and brevity, machine learning model data will generally be referred to herein as “ML model data”. ML model data may be associated with a tenant by being stored in conjunction with a tenant ID for that tenant. The term “ML model data” should be understood to encompass data such as state data and parameter data specifically relating to ML models. The ML model data may correspond to the ancillary data 172 described above, for example.

In this example, the second level 604 comprises a tenant group level 604. In this example, tenant group level 604 comprises any and all tenant groups. In this specific example, the tenant group level 604 comprises exactly one tenant group 614.

In this example, the first and second tenants 606, 608 belong to the tenant group 614. This is depicted in FIG. 6 by arrows 616, 618 pointing to the tenant group 614 from the first and second tenants 606, 608 respectively. The term “belong” is generally used herein to mean is comprised in, is contained in, has joined, is part of, is a child of, or the like.

In this example, the tenant group 614 is associated with tenant group ML model data 620. The tenant group 614 may be associated with the tenant group ML model data 620 via a tenant group ID, or otherwise.

Data, such as metadata, may be stored indicating the association between the tenant group 614 and the first and second tenants 606, 608.

In this example, the tenant group ML model data 620 is based on the first and/or second tenant ML model data 610, 612. In other words, in this example, the tenant group ML model data 620 is based on (i) the first tenant ML model data 610 only, (ii) the second tenant ML model data 612 only, or (iii) both the first and/or second tenant ML model data 610, 612.

### Multi-Tenant Processing—Access Control At Tenant Group Level—Example 1

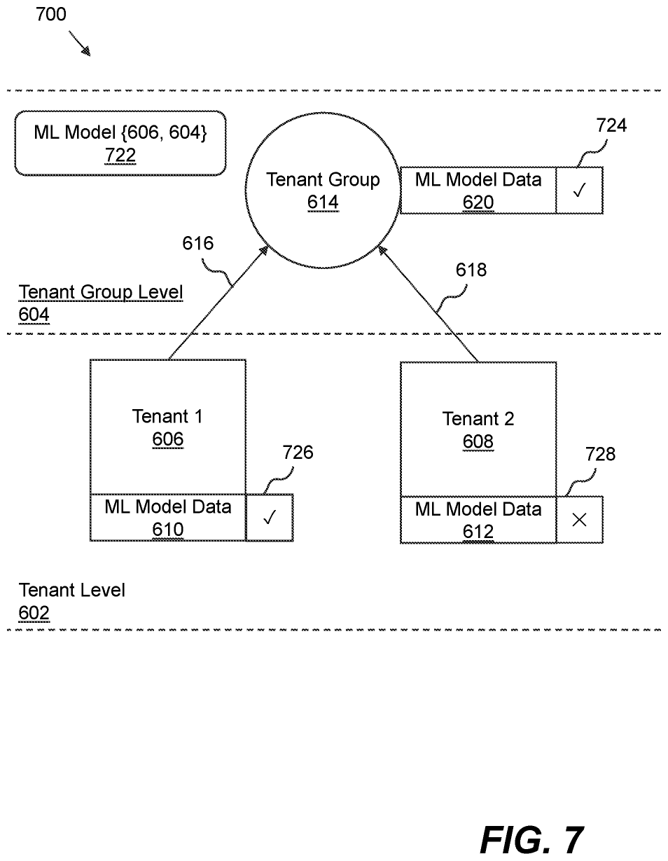

FIG. 7 shows another example hierarchy 700.

The example hierarchy 700 shown in FIG. 7 corresponds to the example hierarchy 600 shown in FIG. 6 but additionally depicts an active ML model. Specifically, FIG. 7 depicts an ML model 722 (denoted “ML Model {606, 604}”) being applied in respect of the first tenant 606 at the tenant group level 604. The notation “ML Model {A, B}” is used herein to indicate an ML model being applied in respect of the A^{th} tenant at the B^{th} level.

In this example, access control is applied in the hierarchy 700 such that the ML model 722 (i) is allowed access to the tenant group ML model data 620 (as indicated at item 724), (ii) is allowed access to the first tenant ML model data 610 (as indicated at item 726) and (iii) is inhibited access to the second tenant ML model data 612 (as indicated at item 728). The term “inhibited” is generally used herein to mean prevented, not allowed, or the like.

As such, the first and second tenant ML model data 610, 612 is segregated in that the ML model 722 being applied in respect of the first tenant 606 has access to the first tenant ML model data 610 and does not have access to the second tenant ML model data 612. In this example, the ML model 722 can use the tenant group ML model data 620 and the first tenant ML model data 610 to perform real-time anomaly detection associated with the first tenant 606. In this example, ML model 722 does not use the second tenant ML model data 612 directly to perform real-time anomaly detection associated with the first tenant 606. More specifically, and as will become more apparent from the description below, in this example, the ML model 722 is not able to access the second tenant ML model data 612 directly. However, in some examples, the tenant group ML model data 620 is based at least in part on the second tenant ML model data 612. In such examples, the ML model 722 may be able to access the tenant group ML model data 620 directly and, thus, data influenced by the second tenant ML model data 612.

Multi-Tenant Processing—Zero or Restricted Contribution from Tenant to Tenant Group ML Model Data

As explained above, in this example, the tenant group ML model data 620 is based on the first and/or second tenant ML model data 610, 612.

In a specific example, the tenant group ML model data 620 (i) is based on the first tenant ML model data 610 and (ii) is not based on the second tenant ML model data 612 or is based on a restricted version of the second tenant ML model data 612.

The restricted version of the second tenant ML model data 612 may be restricted in various different ways relative to the second tenant ML model data 612.

In some examples, the restricted version of the second tenant ML model data 612 comprises a subset of the second tenant ML model data 612. The subset may comprise a historical subset. The historical subset may comprise all elements of the second tenant ML model data 612 predating a given threshold time. In some examples, the restricted version of the second tenant ML model data 612 comprises some or all of the second tenant ML model data 612 with one or more weighting factors applied. The weighting factor may, for example, correspond to a percentage.

As such, in some examples, the tenant group ML model data 620 (i) is based on at least a historic set of the first tenant ML model data 610 and (ii) is not based on at least a historic set of the second tenant ML model data 612 or is based on a restricted version of the historic set of the second tenant ML model data 612.

In this specific example, the second tenant 608 joined the tenant group 614 after the first tenant 606 joined the tenant group 614.

The historic set of the second tenant ML model data 612 may have been generated before the second tenant 608 joined the tenant group 614. As such, by not using the second tenant ML model data 612 or by using the restricted version of the second tenant ML model data 612, the contribution of historic data, which might not be especially reflective of current ML model data of the second tenant 608 can be limited. This, in turn, can result in more accurate tenant group ML model data 620.

In accordance with this specific example, the contribution of the second tenant ML model data 612 to the tenant group ML model data 620 may be zero or may be restricted when the second tenant 608 joins the tenant group 614.

For example, the second tenant 608 may previously have belonged to another tenant group (not shown) and may have moved to the tenant group 614 because the tenant group 614 is a better match for the second tenant 608 than the other tenant group (not shown). Updating the tenant group ML model data 620 with all historic second tenant ML model data 612 may skew the tenant group ML model data 620 as a result of the historic second tenant ML model data 612.

The contribution of the second tenant ML model data 612 to the tenant group ML model data 620 may, however, increase over time while the second tenant 608 belongs to the tenant group 614. Since the second tenant 608 likely moved to the tenant group 614 because the second tenant 608 is more suited to the tenant group 614 than another tenant group, the contribution of the second tenant ML model data 612 to the tenant group ML model data 620 may be increased over time.

For example, the tenant group ML model data 620 may be updated to produce updated tenant group ML model data (not shown). The updated tenant group ML model data may be based on both the first and second tenant ML model data 610, 612. In terms of the second tenant ML model data 612, the updated tenant group ML model data may be derived from the second tenant ML model data 612.

Multi-Tenant Processing—Non-Zero Contribution from Tenants to Tenant Group ML Model Data

As explained above, in this example, the tenant group ML model data 620 is based on the first and/or second tenant ML model data 610, 612.

In another specific example, the tenant group ML model data 620 is based on at least some of each of the first and second ML model data 610, 612. The term “at least some of” is used herein to mean some or all of.

In some examples, the tenant group ML model data 620 is derived based on one or more operations involving at least some of each of the first and second ML model data 610, 612.

The one or more operations may comprise a combination operation. Examples of combination operations include, but are not limited to sum, average, minimum, maximum, standard deviation, and combining into a collection. A “combination operation” may also be referred to as an “aggregating operation”, a “functional operation”, or the like.

### Multi-Tenant Processing—Access Control At Tenant Group Level—Example 2

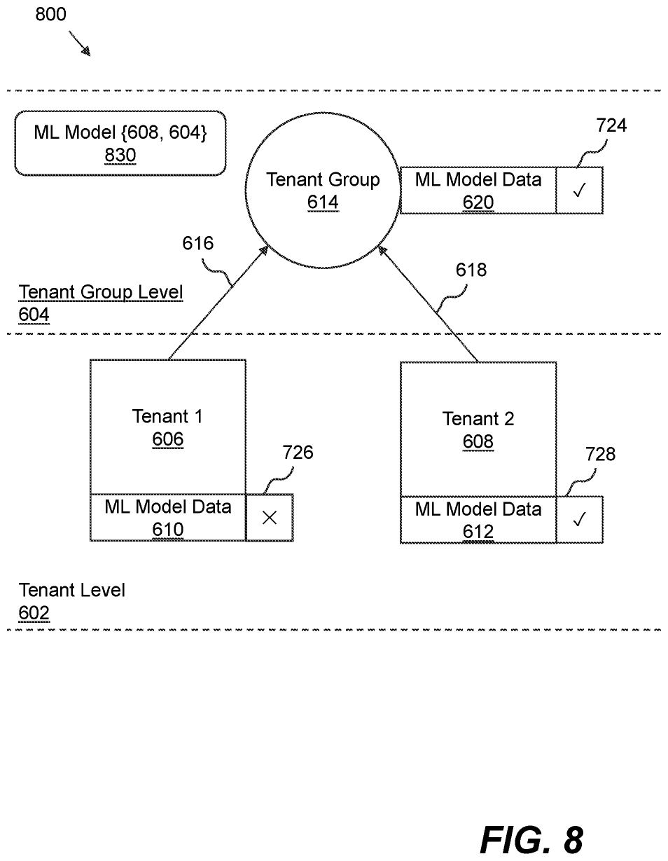

FIG. 8 shows another example hierarchy 800.

FIG. 8 depicts an ML model 830 (denoted “ML Model {608, 604}”) being applied in respect of the second tenant 608 at the tenant group level 604.

The type of the ML model 830 may be the same as the type of the ML model 722 described above with reference to FIG. 7, or may be a different type. However, the ML model 830 is being applied in respect of the second tenant 608 instead of the first tenant 606.

In this example, the ML model 830 (i) is allowed access to the tenant group ML model data 620 (as indicated at item 724), (ii) is inhibited access to the first tenant ML model data 610 (as indicated at item 726), and (iii) is allowed access to the second tenant ML model data 612 (as indicated at item 728).

As such, the first and second tenant ML model data 610, 612 is again segregated in that the ML model 830 being applied in respect of the second tenant 608 has access to the second tenant ML model data 612 and does not have access to the first tenant ML model data 610. In this example, the ML model 830 can use the tenant group ML model data 614 and the second tenant ML model data 612 to perform real-time anomaly detection associated with the second tenant 608.

### Multi-Tenant Processing—Access Control at Tenant Level—Example 1

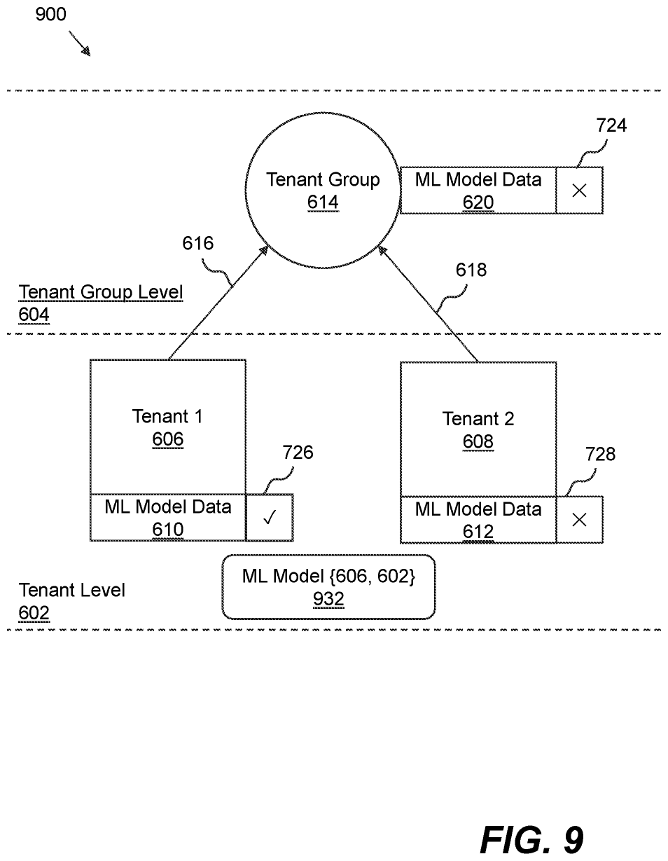

FIG. 9 shows another example hierarchy 900.

FIG. 9 depicts an ML model 932 (denoted “ML Model {606, 602}”) being applied in respect of the first tenant 606 at the tenant level 602.

In this example, the ML model 932 (i) is inhibited access to the tenant group ML model data 620 (as indicated at item 724), (ii) is allowed access to the first tenant ML model data 610 (as indicated at item 726), and (iii) is inhibited access to the second tenant ML model data 612 (as indicated at item 728).

As such, in this example, the ML model 932 can use the first tenant ML model data 610 to perform real-time anomaly detection associated with the first tenant 606. However, in this example, the ML model 932 being applied at the at the tenant level 602 cannot access either (i) the tenant group ML model data 620 at the (higher) tenant group level 604 or (ii) the second tenant ML model data 612 at the (same) tenant level 602.

### Multi-Tenant Processing—Access Control at Tenant Level—Example 2

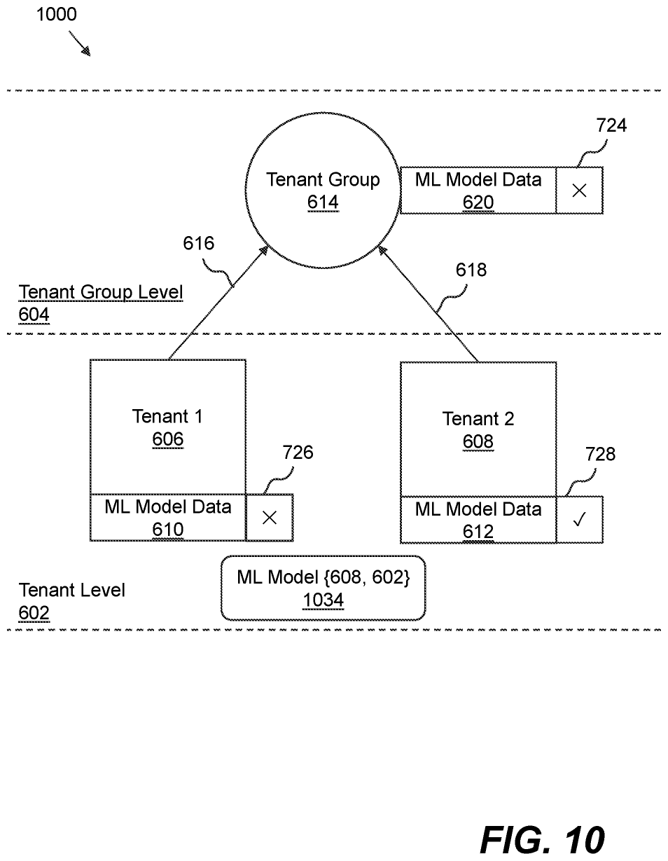

FIG. 10 shows another example hierarchy 1000.

FIG. 10 depicts an ML model 1034 (denoted “ML Model {608, 602}”) being applied in respect of the second tenant 608 at the tenant level 602.

In this example, the ML model 1034 (i) is inhibited access to the tenant group ML model data 620 (as indicated at item 724), (ii) is inhibited access to the first tenant ML model data 610 (as indicated at item 726), and (iii) is allowed access to the second tenant ML model data 612 (as indicated at item 728).

As such, in this example, the ML model 1034 can use the second tenant ML model data 612 to perform real-time anomaly detection associated with the second tenant 608. However, in this example, the ML model 1034 being applied at the at the tenant level 602 cannot access either (i) the tenant group ML model data 620 at the (higher) tenant group level 604 or (ii) the first tenant ML model data 610 at the (same) tenant level 602.

### Multi-Tenant Processing—Permission Setting(s)

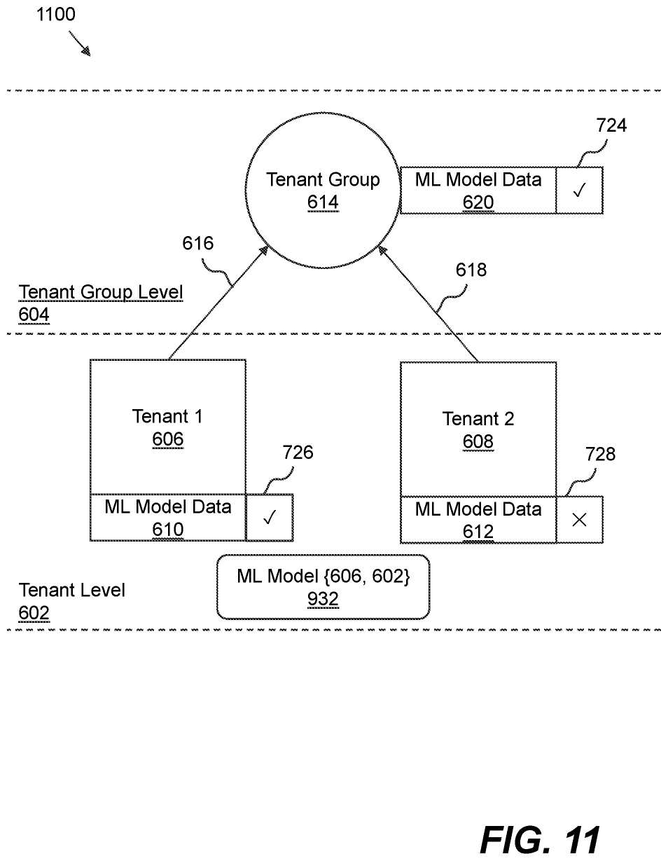

FIG. 11 shows another example hierarchy 1100.

FIG. 11 depicts the ML model 932 (denoted “ML Model {606, 602}”) shown in FIG. 9 being applied in respect of the first tenant 606 at the tenant level 602.

In this example, however, the ML model 932 (at the tenant level 602) is allowed access to the (higher-level) tenant group ML model data 620, as indicated at item 724.

In this specific example, the ML model 932 has selectively been allowed access to the tenant group ML model data 620 based on one or more permission settings being enabled for the ML model 932.

For example, the one or more permission settings may previously have been disabled for the ML model 932 such that, as shown in FIG. 9, the ML model 932 was inhibited access to the tenant group ML model data 620.

The one or more permission settings may subsequently have been enabled for the ML model 932 such that the ML model 932 has access to the tenant group ML model data 620.

The one or more permission settings may be on a per-tenant, per-model, and/or per-level basis.

For example, the one or more permission settings may be enabled for the ML model 932 (in respect of the first tenant 606) such that the ML model 932 has access to both the first tenant ML model data 610 and the tenant group ML model data 620 and may be disabled for the ML model 1034 (in respect of the second tenant 608) such that the ML model 1034 has access to the second tenant ML model data 612 but is inhibited access to the tenant group ML model data 620.

In this example, the ML model 932 can use the tenant group ML model data 620 and the first tenant ML model data 610 to perform real-time anomaly detection associated with the first tenant 606.

### Multi-Tenant Processing—Administrator Level and Access Control at Administrator Level—Example 1

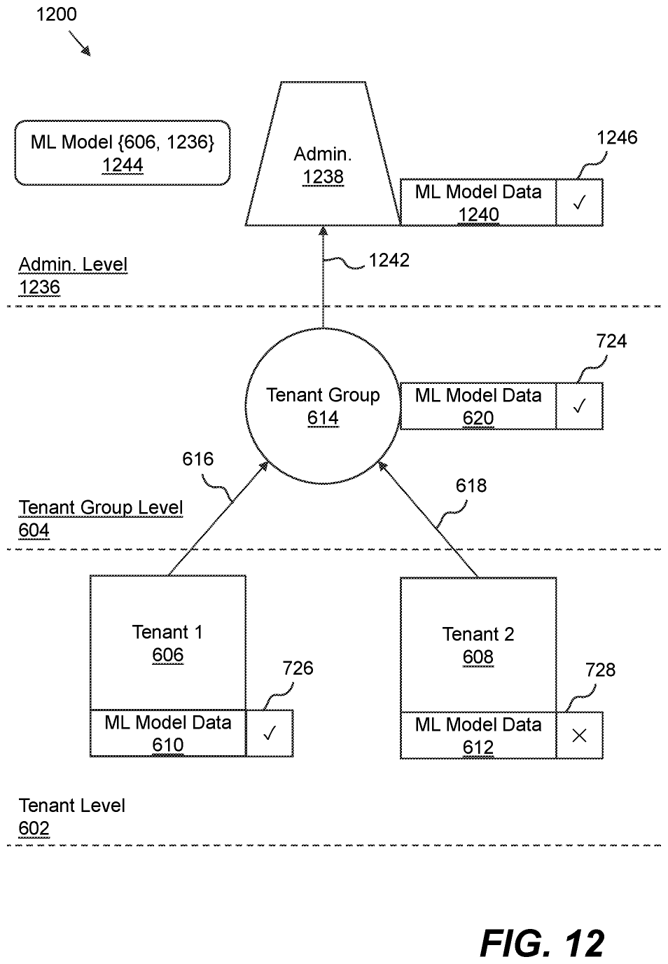

FIG. 12 shows another example hierarchy 1200.

In this example, the hierarchy 1200 comprises a third level 1236. In this example, the third level 1236 comprise an administrator level 1236. In this example, the administrator level 1236 comprises an administrator 1238.

In this example, the administrator 1238 is associated with administrator ML model data 1240. The administrator 1238 may be associated with the administrator ML model data 1240 via an administrator ID, or otherwise.

In this example, the tenant group 614 belongs to the administrator 1238. This is depicted in FIG. 12 by an arrow 1242 pointing to the administrator 1238 from the tenant group 614.

FIG. 12 depicts an ML model 1244 (denoted “ML Model {606, 1236}”) being applied in respect of the first tenant 606 at the administrator level 1236.

In this example, the ML model 1244 (i) is allowed access to the administrator ML model data 1240 (as indicated at item 1246), (ii) is allowed access to the tenant group ML model data 620 (as indicated at item 724), (iii) is allowed access to the first tenant ML model data 610 (as indicated at item 726), and (iv) is inhibited access to the second tenant ML model data 612 (as indicated at item 728).

In this example, the ML model 1244 may use the administrator ML model data 1240, the tenant group ML model data 620 and the first tenant ML model data 610 to perform real-time anomaly detection associated with the first tenant 606.

Access control can be applied in respect of the second tenant 608 at the administrator level 1236 in a similar in manner, whereby an ML model being applied in respect of the second tenant 608 at the administrator level 1236 may use the administrator ML model data 1240, the tenant group ML model data 620 and the second tenant ML model data 612 to perform real-time anomaly detection associated with the second tenant 608.

### Multi-Tenant Processing—Access Control at Tenant Group Level—Example 3

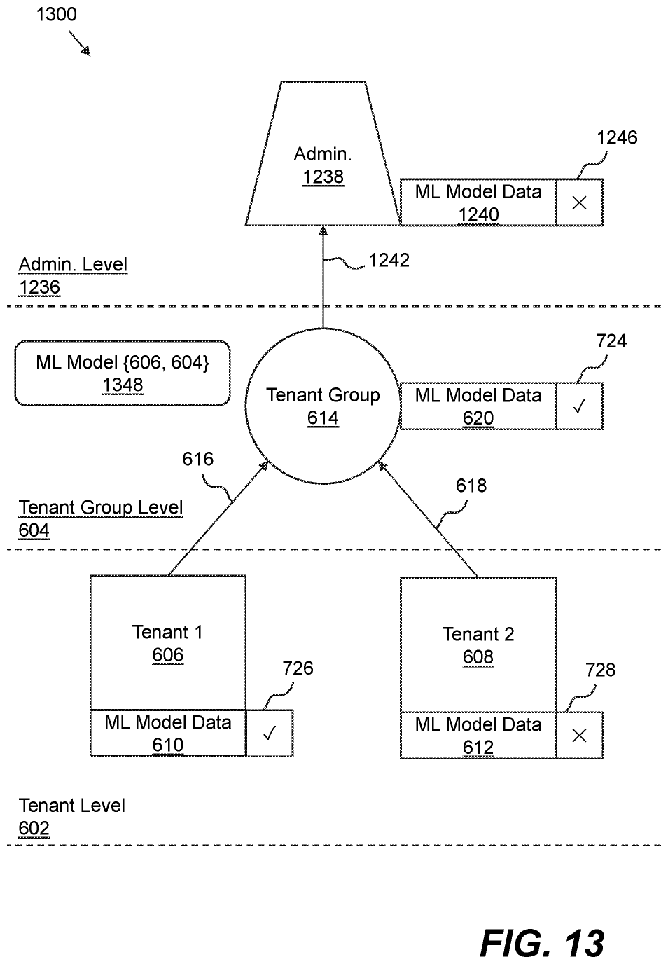

FIG. 13 shows another example hierarchy 1300.

FIG. 13 depicts an ML model 1348 (denoted “ML Model {606, 604}”) being applied in respect of the first tenant 606 at the tenant group level 604.

In this example, the ML model 1348 (i) is inhibited access to the administrator ML model data 1240 (as indicated at item 1246), (ii) is allowed access to the tenant group ML model data 620 (as indicated at item 724), (iii) is allowed access to the first tenant ML model data 610 (as indicated at item 726), and (iv) is inhibited access to the second tenant ML model data 612 (as indicated at item 728).

In this example, the ML model 1348 may use the tenant group ML model data 620 and the first tenant ML model data 610 to perform real-time anomaly detection associated with the first tenant 606.

The ML model 1348 may, however, be given permission to access the administrator ML model data 1240 as described above.

### Multi-Tenant Processing—Further Tenant Group(s)

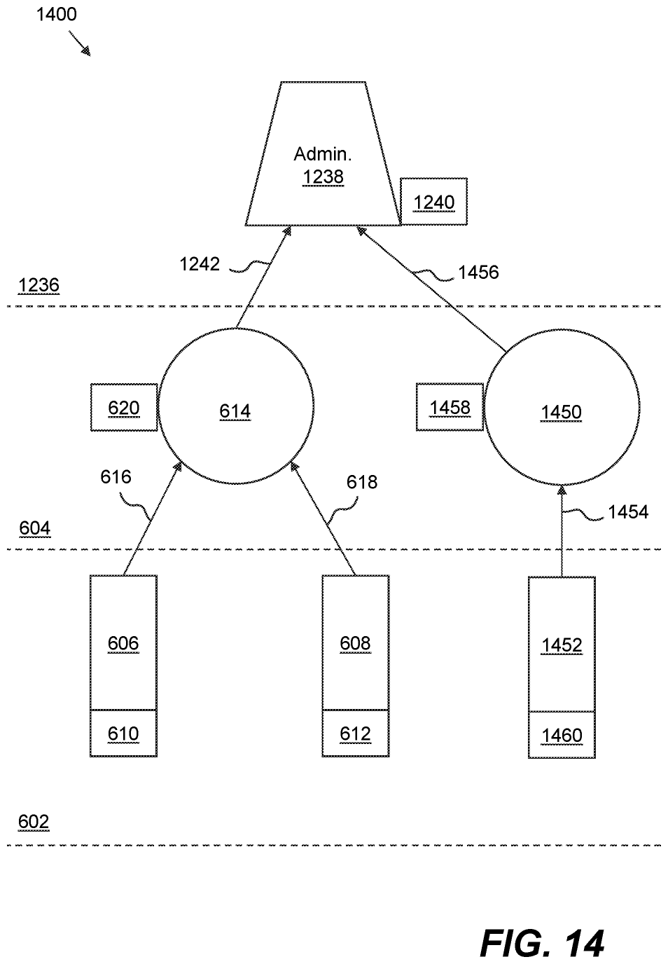

FIG. 14 shows another example hierarchy 1400.

For ease of representation, some elements of the example hierarchies described above with reference to FIGS. 6 to 13 are represented differently in FIG. 14 and in certain subsequent FIGS.

In this example, the tenant group level 604 comprises a further tenant group 1450. Although a single further tenant group 1450 is shown in FIG. 14, the tenant group level 604 may comprise more than one further tenant group 1450 in other examples.

In this example, a further tenant 1452 belongs to the further tenant group 1450. This is depicted in FIG. 14 by an arrow 1454 pointing to the further tenant group 1450 from the further tenant 1452. Although a single further tenant 1452 is shown in FIG. 14, more than one further tenant 1452 may belong to the further tenant group 1450 in other examples.

In general, a hierarchy in accordance with examples described herein may comprise one or more tenant groups, and a tenant group may comprise one or more tenants.

In this example, the first and second tenants 606, 608 do not belong to the further tenant group 1450, and the further tenant 1452 does not belong to the tenant group 614.

In this example, the further tenant group 1450 belongs to the administrator 1238. This is depicted in FIG. 14 by an arrow 1456 pointing to the administrator 1238 from the further tenant group 1450.

In this example, the further tenant group 1450 is associated with further tenant group ML model data 1458. For example, the further tenant group 1450 may be associated with the further tenant group ML model data 1458 via a (further) tenant group ID, or otherwise.

In this example, the further tenant 1452 is associated with further tenant ML model data 1460. For example, the further tenant 1452 may be associated with the further tenant ML model data 1460 via a (further) tenant ID, or otherwise.

### Multi-Tenant Processing—Access Control at Tenant Group Level—Example 4

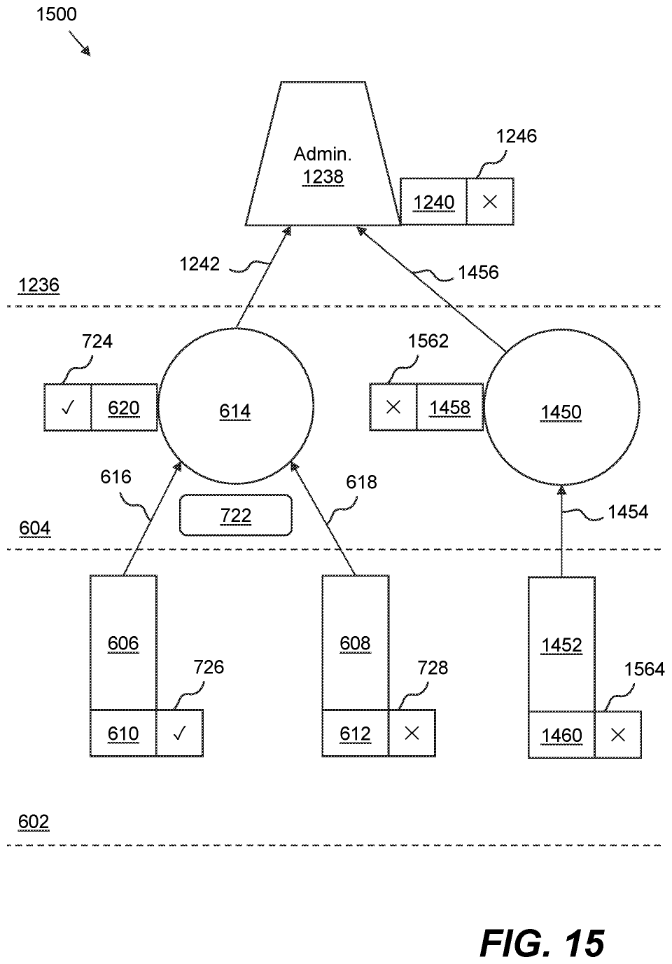

FIG. 15 shows another example hierarchy 1500.

In this example, the ML model 722 is being applied in respect of the first tenant 606 at the tenant group level 604.

In this example, the ML model 722 (i) is inhibited access to the further tenant group ML model data 1458 (as indicated at item 1562), and (ii) is inhibited access to the further tenant ML model data 1460 (as indicated at item 1564).

In addition, in this specific example, the ML model 722 (i) is allowed access to the first tenant ML model data 610 and the tenant group ML model data 620 (as indicated at items 726 and 724 respectively), and (ii) is inhibited access to the second tenant ML model data 612 and the administrator ML model data 1240, as indicated at items 728 and 1246 respectively.

In this example, the ML model 722 may use the tenant group ML model data 614 and the first tenant ML model data 610 to perform real-time anomaly detection associated with the first tenant 606.

### Multi-Tenant Processing—Access Control at Administrator Level—Example 2

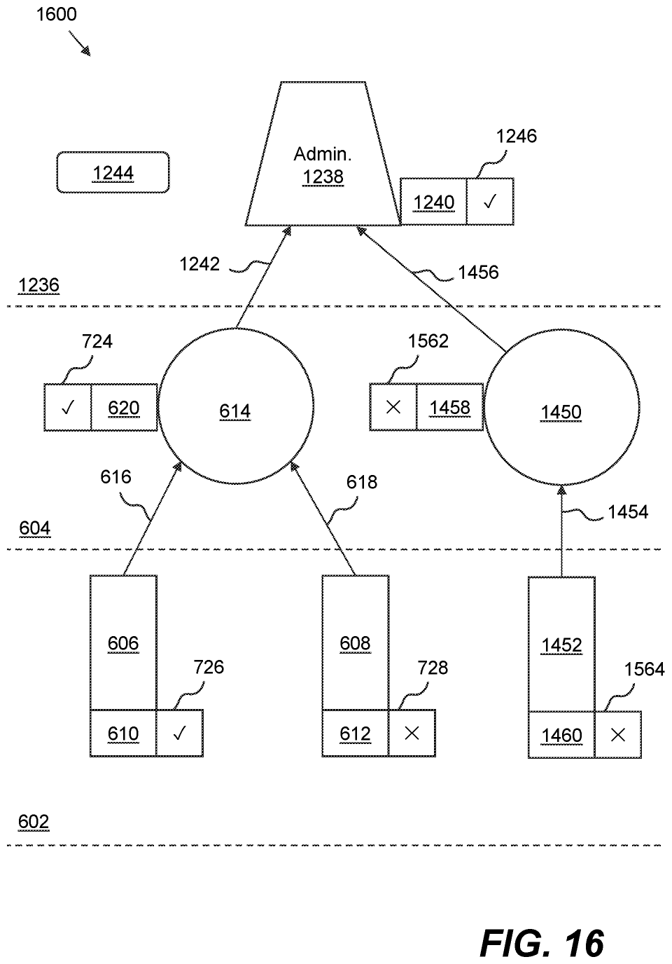

FIG. 16 shows another example hierarchy 1600.

In this example, the ML model 1244 is being applied in respect of the first tenant 606 at the administrator level 1236.

In this example, the ML model 1244 (i) is inhibited access to the further tenant group ML model data 1458 (as indicated at item 1562) and (i) is inhibited access to the further tenant ML model data 1460 (as indicated at item 1564).

In addition, in this specific example, the ML model 1244 (i) is allowed access to the first tenant ML model data 610, the tenant group ML model data 620, and the administrator ML model data 1240 (as indicated at items 726, 724 and 1246 respectively), and (ii) is inhibited access to the second tenant ML model data 612 (as indicated at item 728).

In this example, the ML model 1244 may use the administrator ML model data 1240, the tenant group ML model data 614 and the first tenant ML model data 610 to perform real-time anomaly detection associated with the first tenant 606.

### Multi-Tenant Processing—Additional Tenant(s) and Access Control at Tenant Group Level-Example 5

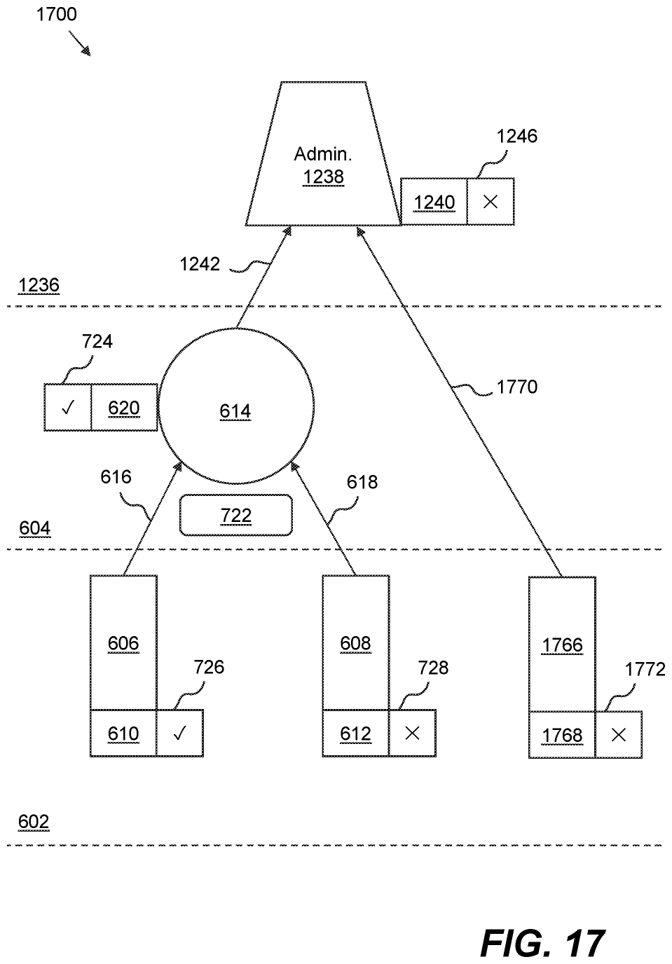

FIG. 17 shows another example hierarchy 1700.

In this example, the hierarchy 1700 comprises an additional tenant 1766.

In this example, the additional tenant 1766 is depicted as being comprised in the same horizontal level as the first and second tenants 606, 608, i.e. in the tenant level 602. However, it is emphasised again that this is for ease of explanation. The additional tenant 1766 could be depicted in the same horizontal level as the tenant group 614 while still being in the logical tenant level 602.

In this example, the additional tenant 1766 is associated with additional tenant ML model data 1768. For example, the additional tenant 1766 may be associated with the additional tenant ML model data 1768 via a (n additional) tenant ID, or otherwise.

In this example, the additional tenant 1766 belongs to the administrator 1238. This is depicted in FIG. 17 by an arrow 1770 pointing to the administrator 1238 from the additional tenant 1766.

In this example, the additional tenant 1766 may be said to belong “directly” to the administrator 1238 in that there are no intermediate elements of the hierarchy 1700 between the additional tenant 1766 and the administrator 1238.

Similarly, (i) the tenant group 614 may be said to belong “directly” to the administrator 1238 in that there are no intermediate elements of the hierarchy 1700 between the tenant group 614 and the administrator 1238 and (ii) the first and second tenants 606, 608 may be said to belong “directly” to the tenant group 614 in that there are no intermediate elements of the hierarchy 1700 between the first and second tenants 606, 608 and the tenant group 614.

However, the first and second tenants 606, 608 may be said to belong “indirectly” to the administrator 1238 in that there is at least one intermediate element of the hierarchy 1700 between the first and second tenants 606, 608 and the administrator 1238. In this example, the at least one intermediate element comprises the tenant group 614.

In this example, the ML model 722 is being applied in respect of the first tenant 606 at the tenant group level 604.

In this example, the ML model 722 is inhibited access to the additional tenant ML model data 1768 (as indicated at item 1772).

In addition, in this specific example, the ML model 722 (i) is allowed access to the first tenant ML model data 610 and the tenant group ML model data 620 (as indicated at items 726 and 724 respectively), and (ii) is inhibited access to the second tenant ML model data 612 and the administrator ML model data 1240 (as indicated at items 728 and 1246 respectively).

### Multi-Tenant Processing—Access Control at Administrator Level—Example 3

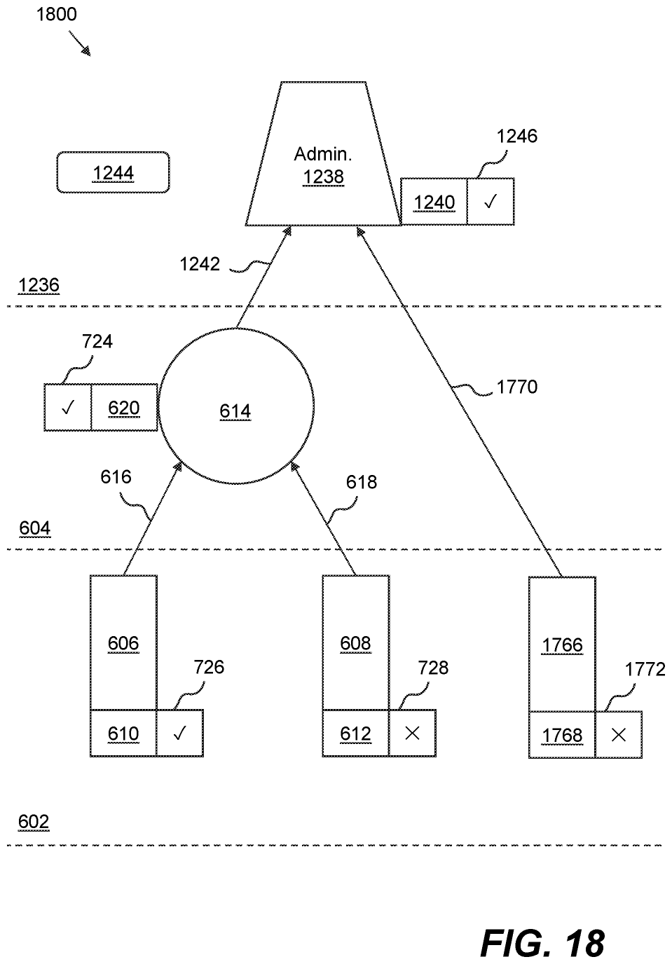

FIG. 18 shows another example hierarchy 1800.

In this example, the ML model 1244 is being applied in respect of the first tenant 606 at the administrator level 1238.

In this example, the ML model 1244 is inhibited access to the additional tenant ML model data 1768 (as indicated at item 1772).

In addition, in this specific example, the ML model 1244 (i) is allowed access to the first tenant ML model data 610, the tenant group ML model data 620, and the administrator ML model data 1240 (as indicated at items 726, 724 and 1244 respectively), and (ii) is inhibited access to the second tenant ML model data 612 (as indicated at item 728).

Although FIGS. 14 to 16 relate to example hierarchies 1400, 1500, 1600 with at least one further access group 1450 having at least one further tenant 1452 and FIGS. 17 and 18 separately relate to example hierarchies 1700, 1800 with at least one additional tenant 1766, other example hierarchies may comprise both at least one further access group 1450 having at least one further tenant 1452 and at least one additional tenant 1766.

### Multi-Tenant Processing—Predetermined Action(s) in Response to Tenant Leaving Tenant Group

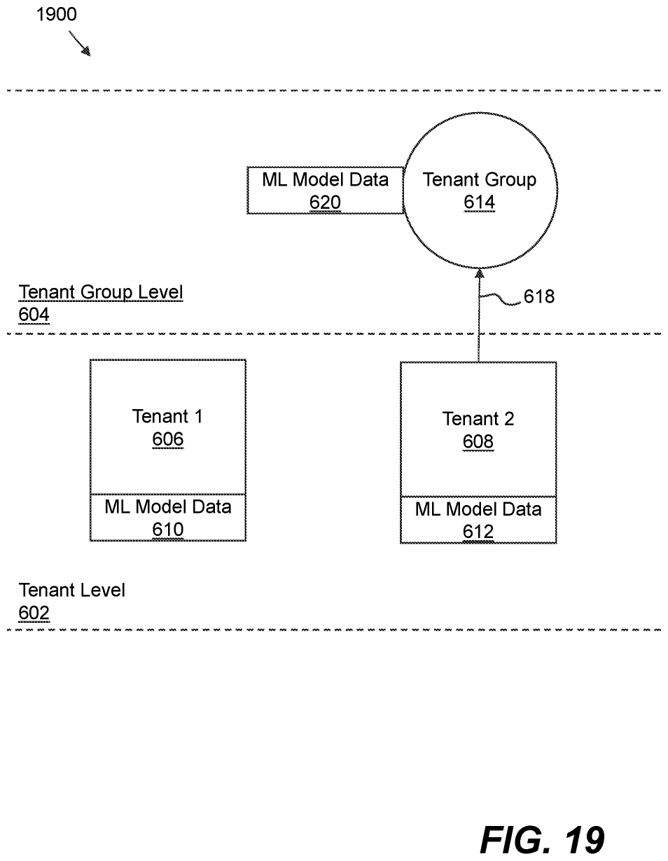

FIG. 19 shows another example hierarchy 1900.

FIG. 19 depicts a scenario in which the first tenant 606 no longer belongs to the tenant group 614.

The first tenant 606 may have been removed from the tenant group 614 based on one or more removal factors. Examples of removal factors include, but are not limited to, a user request, insufficiently strong match between the first tenant 606 and the tenant group 614, and so on. For example, the first tenant ML model data 610 may represent an average transaction amount associated with the first tenant 606. If the average transaction amount is outside a standard deviation of average transaction amounts of other tenants belonging to the tenant group 614, an insufficiently strong match between the first tenant 606 and the tenant group 614 may be determined.

The first tenant 606 may now belong to the administrator (not shown) or may belong to another tenant group (not shown). Additionally, while FIG. 19 shows an example in which the first tenant 606 is still part of the hierarchy 1900, the first tenant 606 may no longer be part of the hierarchy 1900 in other examples.

In some examples, a predetermined action is performed in relation to the tenant group ML model data 620 in response to the first and/or second tenant 606, 608 no longer belonging to the tenant group 614.

An example of such a predetermined action is updating the tenant group ML model data 620 such that the tenant group ML model data 620 is no longer based on the first tenant ML model data 610 or is based on a restricted version of the first tenant ML model data 610.

For example, where the tenant group ML model data 620 comprises a compilation, such as a list, of the first and second tenant ML model data 610, 612, the first tenant ML model data 610 may be deleted from the compilation.

Where, for example, the tenant group ML model data 620 is based on historic averages of the first and second tenant ML model data 610, 612, the first tenant ML model data 610 may no longer be taken into account for future averages but there may still remain contributions from historic first tenant ML model data 610 in the tenant group ML model data 620 for some time.

While this specific example concerns a tenant leaving a tenant group, one or more corresponding predetermined actions may be taken in response to a tenant no longer belonging directly to an administrator and/or a tenant group no longer belonging directly to an administrator.

### Multi-Tenant Processing—Access Control at Tenant Group Level—Example 6

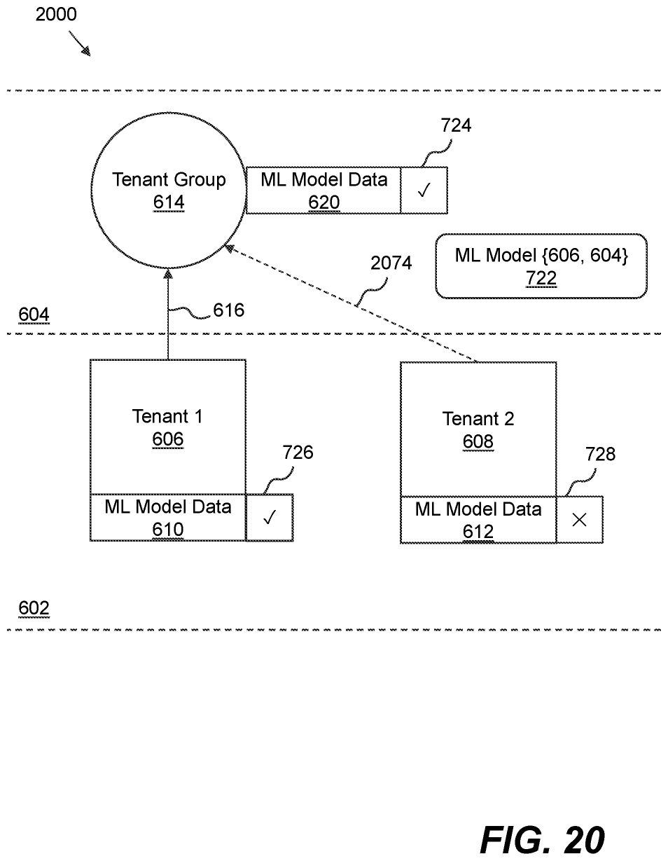

FIG. 20 shows another example hierarchy 2000.

In this example, the hierarchy 2000 comprises a tenant level 602 comprising first and second tenants 606, 608 associated with first and second tenant ML model data 610, 612 respectively.

In this example, the hierarchy 2000 comprises a tenant group level 604 comprising a tenant group 614 to which at least the first tenant 606 belongs.

The tenant group 614 is associated with tenant group ML model data 620. The tenant group ML model data 620 is based at least on the first tenant ML model data 610.

In this example, the second tenant 608 may or may not belong to the tenant group 614. This is depicted in FIG. 20 by a broken-line arrow 2074 pointing to the tenant group 614 from the second tenant 608.

For example, the second tenant 608 may belong to the tenant group 614, may belong to an administrator (not shown), may belong to another tenant group (not shown), or otherwise.

In this example, the tenant group ML model data 620 (i) may be based on the first tenant ML model data 610 and (ii) may not be based on the second tenant ML model data 612 or may be based on a restricted version of the second tenant ML model data 612.

In this examples, the ML model 722 (i) is allowed access to the tenant group ML model data 620 and the first tenant ML model data 610 (as indicated at items 724 and 726 respectively), and (ii) is inhibited access to the second tenant ML model data 612 (as indicated at item 728).

Although this specific example relates to the ML model 722, in another example, a machine learning model (not shown) being applied in respect of the first tenant 606 at the tenant level 602 may also (i) be allowed access to the tenant group ML model data 724 and the first tenant ML model data 610 (as indicated at items 724 and 726 respectively), and (ii) be inhibited access to the second tenant ML model data 612 (as indicated at item 728). The machine learning model (not shown) being applied in respect of the first tenant 606 at the tenant level 602 may not initially have been allowed to access the tenant group ML model data 620 but may have been granted permission, for example by enabling one or more permission settings.

### Multi-Tenant Processing—Access Control Method

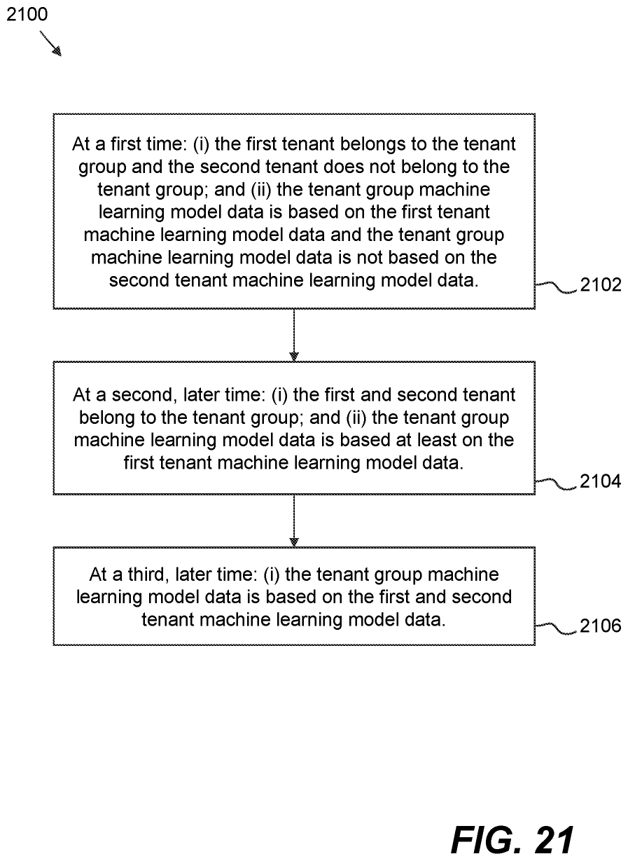

FIG. 21 shows an example access control method 2100.

The example method 2100 controls access to ML model data in a multi-tenant ML system having a ML model data access hierarchy. The ML model data access hierarchy may correspond to one or more example hierarchies described herein or otherwise.

In this example, the ML model data access hierarchy comprises (i) a first tenant 606 associated with first tenant ML model data 610; (ii) a second tenant 608 associated with second tenant ML model data 612; and (iii) a tenant group 614 associated with tenant group ML model data 620.

As indicated by item 2102, at a first time: (i) the first tenant 606 belongs to the tenant group 614 and the second tenant 608 does not belong to the tenant group 614; and (ii) the tenant group ML model data 620 is based on the first tenant ML model data 610 and the tenant group ML model data 620 is not based on the second tenant ML model data 612.

As indicated by item 2104, at a second, later time (i.e. later than the first time): (i) the first and second tenants 606, 608 belong to the tenant group 614; and (ii) the tenant group ML model data 620 is based at least on the first tenant ML model data 610.

As indicated by item 2106, at a third, later time (i.e. later than the second time): the tenant group ML model data 620 is based on the first and second tenant ML model data 610, 612.

### Multi-Tenant Processing—Multi-Tenant Machine Learning System

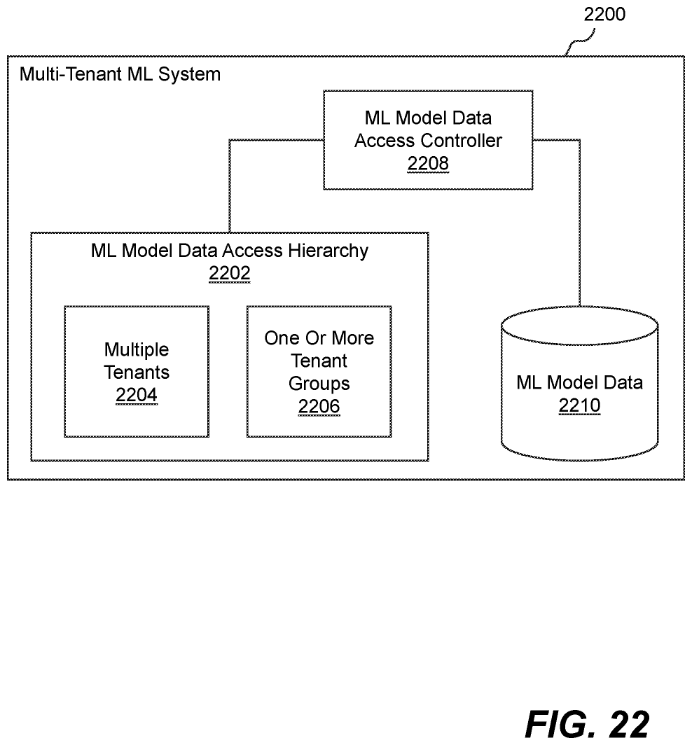

FIG. 22 shows an example multi-tenant ML system 2200.

In this example, the system 2200 has access to an ML model data access hierarchy 2202. The ML model data access hierarchy 2202 may correspond to one or more example hierarchies described herein or otherwise.

The hierarchy 2202 comprises multiple tenants 2204 and comprises one or more tenant groups 2206.

The system 2200 comprises an ML model data access controller 2208. The ML model data access controller 2208 is configured to control access to ML model data 2210 in accordance with the ML model data access hierarchy 2202.

The ML model data access controller 2208 may comprise, may be implemented using, or may otherwise employ one or more processors and one or more memories to perform ML model data access control. The one or more memories may comprise instructions which, when executed by the one or more processors, cause the one or more processors to perform ML model data access control.

### Multi-Tenant Processing—Machine Learning Model Data Access Hierarchy—Example 2

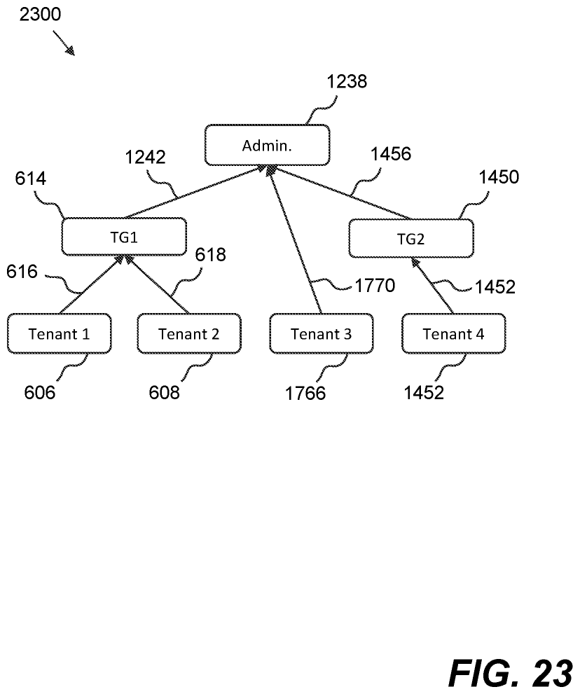

FIG. 23 shows an example hierarchy 2300.

In this example, the hierarchy comprises (i) a tenant group 614 belonging to an administrator 1238 and comprising first and second tenants 606, 608, (ii) an additional tenant 1766 belonging directly to the administrator 1238, and (iii) a further tenant group 1450 belonging to the administrator 1238 and comprising a further tenant 1452.

### Multi-Tenant Processing—Multi-Level Access Control—Example 1

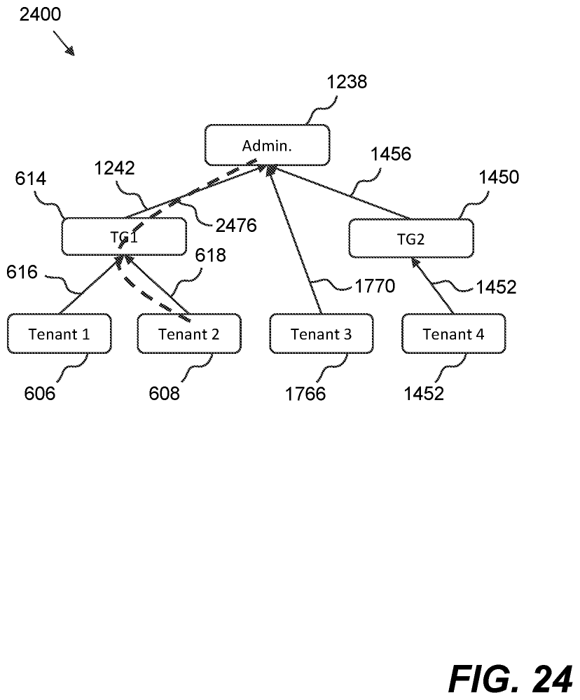

FIG. 24 shows an example hierarchy 2400.

The example hierarchy 2400 corresponds to the example hierarchy 2300 described above with reference to FIG. 23, except that the example hierarchy 2400 additionally depicts access control in respect of the second tenant 608 using a broken curved line 2476.

In this example, when events are processed for the second tenant 608, the active parts of the hierarchy 2400 are indicated by the broken curved line 2476.

In this specific example, for a model active in respect of the second tenant 608 at the administrator level, the model (i) has access to administrator ML model data, tenant group ML model data and second tenant ML model data and (ii) does not have access to first tenant ML model data, additional tenant ML model data, further tenant group ML model data or further tenant ML model data.

In this specific example, for a model active in respect of the second tenant 608 at the tenant group level, the model (i) has access to tenant group ML model data and second tenant ML model data, (ii) does not have access to first tenant ML model data, additional tenant ML model data, further tenant group ML model data or further tenant ML model data, and (iii) may have access to administrator ML model data.

In this specific example, for a model active in respect of the second tenant 608 at the tenant level, the model (i) has access to second tenant ML model data, (ii) does not have access to first tenant ML model data, additional tenant ML model data, further tenant group ML model data or further tenant ML model data, and (iii) may have access to administrator ML model data and/or tenant group ML model data.

As such, in this specific example, none of the models active in respect of the second tenant 608 have access to first tenant ML model data, additional tenant ML model data, further tenant group ML model data or further tenant ML model data. As explained above, this provides a high degree of data segregation between different tenants.

However, in other examples, such models may be given full or partial access to first tenant ML model data, additional tenant ML model data, further tenant group ML model data or further tenant ML model data.

For example, a business relationship may change between the second tenant 608 and the additional tenant 1766 such that the second tenant 608 may have full or partial access to the additional tenant ML model data. This can provide relaxed data segregation as between the second and additional tenants 608, 1766 while still providing strong data segregation with respect to other tenants.

This possibility of relaxed data segregation applies analogously to other examples described herein.

### Multi-Tenant Processing—Multi-Level Access Control—Example 2

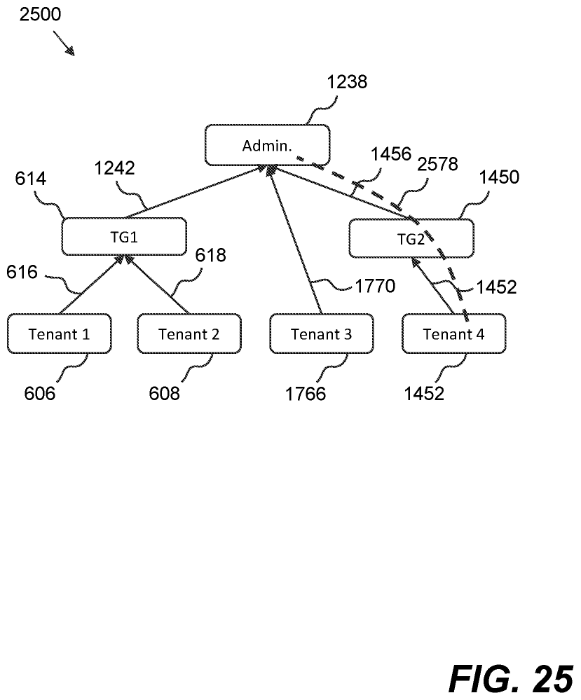

FIG. 25 shows an example hierarchy 2500.

The example hierarchy 2500 corresponds to the example hierarchy 2300 described above with reference to FIG. 23, except that the example hierarchy 2500 additionally depicts access control in respect of the further tenant 14520 using a broken curved line 2578.

In this example, when events are processed for the further tenant 1452, the active parts of the hierarchy 2500 are indicated by the broken curved line 2578.

In this specific example, for a model active in respect of the further tenant 1452 at the administrator level, the model (i) has access to administrator ML model data, further tenant group ML model data and further tenant ML model data and (ii) does not have access to first tenant ML model data, second tenant ML model data, tenant group ML model data, or additional tenant ML model data.

In this specific example, for a model active in respect of the further tenant 1452 at the tenant group level, the model (i) has access to further tenant group ML model data and further tenant ML model data, (ii) does not have access to first tenant ML model data, second tenant

ML model data, tenant group ML model data, or additional tenant ML model data, and (iii) may have access to administrator ML model data.

In this specific example, for a model active in respect of the further tenant 1452 at the tenant level, the model (i) has access to further tenant ML model data, (ii) does not have access to first tenant ML model data, second tenant ML model data, tenant group ML model data, or additional tenant ML model data, and (iii) may have access to administrator ML model data and/or further tenant group ML model data.

### Multi-Tenant Processing—Additional Technical Effects

As explained above, splitting a system up by use case or internal organisations may involve having multiple integrations and multiple systems being combined together. This can lead to a difficult initial implementation and difficulties if a new tenant is to be added.

In contrast, examples described herein keep analytics and configuration cleanly demarcated.

Additionally, in contrast to systems in which rules have to directly reference particular subsets of data, tenant groups as described herein provide clean, logical buckets that tenants sit under.

Examples also provide tenant groups with, effectively, layers of analytical strategy.

The example multi-tenancy solutions described herein are especially flexibility. Some users may have view-only privileges, whereas other users (for example with their own fraud teams) may be able to create and edit their own rules all on the same Solution.

Additionally, the Solution may be adapted to leverage the consortia data across other users or, where applicable, exclude them if this could impact performance of the model.

Furthermore, a given user can provide the services described herein to other users (for example using tenant groups), leveraging their own fraud solution in respect of other users and not just using their fraud solution to solve their own fraud-related challenges.

As such, the creation of tenant groups with multi-tenants, and learnings cascading across groups, without having to create separate instances of the system, is an effective, targeted, and configurable solution.

Machine learning generally involves large quantities of data. The hierarchies described herein enable efficient access to different parts of such data.

Data isolation may also be especially relevant for machine learning data, particularly in the context of fraud detection. Examples described herein use hierarchies to leverage the above-described efficient data access they provide, while also providing controlled access to machine learning data. In particular, the hierarchies described herein may enable full data segregation between different tenants, while enabling higher-level entities access to ML model data for multiple different tenants.

### Multi-Tenant Processing—Example Use Case

A non-limiting example use case of the systems and methods described herein will be provided.

In this example, a hierarchy comprises an administrator, a first tenant group comprising first and second tenants and a second tenant group comprising third and fourth tenants.

In this example, the first and second tenants are businesses in the same business sector as each other and the first tenant group is associated with the businesses sector with which the first and second tenants are associated. Similarly, the third and fourth tenants are businesses in the same business sector as each other and the second tenant group is associated with the businesses sector with which the third and fourth tenants are associated.

The different business sectors may be associated with different levels of fraud risk, may have different rules, may have different data maturation properties, etc.

First tenant group tenant ML model data associated with the first tenant group may be based on first and second tenant ML model data associated with the first and second tenants respectively. Similarly, second tenant group tenant ML model data associated with the second tenant group may be based on third and fourth tenant ML model data associated with the third and fourth tenants respectively.

In examples, a model running in respect of a given tenant cannot directly access ML model data of another tenant, albeit the model might be able to access ML model data of a tenant group comprising the other tenant and/or administrator ML model data. This provides effective data segregation within a single, multi-tenant platform.

An analyst associated with, for example, the first tenant may be able to perform analytics based on the first tenant ML model data, but not based on the second tenant ML model data.

However, an analyst associated with the first tenant group (for example an account manager for the business sector with which the first and second tenants are associated) may be able to perform analytics based on the first tenant ML model data, the second tenant ML model data, and the first tenant group ML model data.

In this example, over time, characteristics of the third tenant businesses change to be more like the first and second tenant businesses.

As such, the third tenant may be moved to the first tenant group such that the first, second and third tenants belong to the first tenant group, and the fourth tenant belongs to the fourth tenant group.

It should be understood that the third tenant may readily be moved from the second tenant group to the first tenant group by updating data, such as metadata, such that the third tenant is associated with the first tenant group rather than the second tenant group. This move takes place within a single platform as described herein, whereas this would not be possible where different installs are used for different tenants.

While the third tenant may now have characteristics that are more closely aligned with those of the first and second tenants, the third tenant ML model data may comprise at least some historic data. If the first tenant group ML model data were updated as soon as the third tenant joins to include all of the third tenant ML model data (in particular, the historic data), the first tenant group ML model data may be less representative of the (current) first, second and third tenant ML model data than if the historic third tenant ML model data were not used, or were used in a restricted way.

Over time, and given the characteristics of the third tenant are more similar to those of the first and second tenants, a higher (for example, full) contribution from the third tenant ML model data may be used for the first tenant group ML model data.

Similarly, once the third tenant is no longer in the second tenant group, the contribution of the third tenant ML model data to the second tenant group ML model data may be removed or may be reduced. For example, if the third tenant ML model data were {m_31, m_32, m_33, . . . }, the fourth tenant ML model data were {m_41, m_42, m_43, . . . }, and the second tenant group ML model data were a compilation of the third and fourth tenant ML model data, for example, {m_31, m_32, m_33, . . . ; m_41, m_42, m_43, . . . }, some or all of the third tenant ML model data could readily be deleted from the second tenant group ML model data with immediate effect upon the third tenant leaving the second tenant group.

### Multi-Tenant Processing—Additional Features

In examples described above, a given tenant either belongs to a single tenant group or belongs directly to an administrator. In other words, in such example, a tenant can only have one parent.

If multiple types of analytics are being run, each tenant may be represented using multiple different tenant IDs, for different analytics hierarchies, within the system.

However, more generally, a given tenant may belong to one or more tenant groups and/or may belong directly to an administrator. For example, given tenant may belong to two different tenant groups, may belong to one tenant group and also directly to an administrator, etc.

In examples described above, hierarchies comprise two, three or four (logical) levels. However, hierarchies may comprise a different number of levels in other examples.

Examples described above relate to models in the form of machine learning models.

In other examples, another type of model, more specifically learning model, may be used. An example of another type of learning model is a rule-based learning model. An example of a rule-based learning model is an adaptive ruleset model, which may also be referred to as a rule-based adaptive model. As such, although examples described above relate to machine learning models, they may also be applied to other types of learning models such as, but not limited to, adaptive rulesets. References to “machine learning model”, including, for example, in terms such as ‘machine learning model data’, should be understood accordingly.

It will be appreciated that the optional features described hereinabove in respect of embodiments of any aspect of the invention apply equally, where technically appropriate, to the other aspects of the invention.

Where technically appropriate, embodiments of the invention may be combined. Embodiments are described herein as comprising certain features/elements. The disclosure also extends to separate embodiments consisting or consisting essentially of said features/elements.

The method or methods in accordance with any embodiments of the invention may be computer-implemented.

Exemplary embodiments of the invention described hereinabove each may extend to a non-transitory computer-readable medium comprising instructions that, when executed by a processor, cause the processor to carry out the method of such aspects of the invention.

Exemplary embodiments of the invention described hereinabove each may extend to a computer software product comprising instructions that, when executed by a processor, cause the processor to carry out the method of such aspects of the invention.

Technical references such as patents and applications are incorporated herein by reference.

Any embodiments specifically and explicitly recited herein may form the basis of a disclaimer either alone or in combination with one or more further embodiments.

While specific embodiments of the present invention have been described in detail, it will be appreciated by those skilled in the art that the embodiments described in detail are not limiting on the scope of the claimed invention.

1. A method of controlling access to machine learning model data in a multi-tenant machine learning system having a machine learning model data access hierarchy, the machine learning model data access hierarchy comprising:
a tenant level comprising first and second tenants associated with first and second tenant machine learning model data respectively; and
a tenant group level comprising a tenant group to which the first and second tenants belong, wherein the tenant group is associated with tenant group machine learning model data, and wherein the tenant group machine learning model data is based on the first and/or second tenant machine learning model data,
the method comprising, for a machine learning model being applied in respect of the first tenant at the tenant group level:
allowing access to the tenant group machine learning model data and the first tenant machine learning model data; and
inhibiting access to the second tenant machine learning model data.

2. A method according to claim 1, wherein:
the tenant group machine learning model data is based on the first tenant machine learning model data; and
the tenant group machine learning model data is not based on the second tenant machine learning model data or is based on a restricted version of the second tenant machine learning model data.

3. A method according to claim 1, wherein the second tenant joined the tenant group after the first tenant joined the tenant group.

4. A method according to claim 1, wherein:
the tenant group machine learning model data is based on at least a historic set of the first tenant machine learning model data; and
the tenant group machine learning model data is not based on at least a historic set of the second tenant machine learning model data or is based on a restricted version of the historic set of the second tenant machine learning model data.

5. A method according to claim 4, wherein the historic set of the second tenant machine learning model data was generated before the second tenant joined the tenant group.

6. A method according to claim 1, wherein the tenant group machine learning model data is updated to produce updated tenant group machine learning model data and wherein the updated tenant group machine learning model data is based on both the first and second tenant machine learning model data.

7. A method according to claim 1, wherein the tenant group machine learning model data is based on at least some of each of the first and second machine learning model data.

8. A method according to claim 7, wherein the tenant group machine learning model data is derived based on one or more operations involving said at least some of each of the first and second machine learning model data.

9. A method according to claim 1, wherein the method comprises, for a machine learning model being applied in respect of the second tenant at the tenant group level:
allowing access to the tenant group machine learning model data and the second tenant machine learning model data; and
inhibiting access to the first tenant machine learning model data.

10. A method according to claim 1, the method comprising, for a machine learning model being applied in respect of the first and/or second tenant at the tenant level, inhibiting access to the tenant group machine learning model data.

11. A method according to claim 1, the method comprising, for a machine learning model being applied in respect of the first and/or second tenant at the tenant level, selectively allowing access to the tenant group machine learning model data based on one or more permission settings being enabled for the machine learning model being applied in respect of the first and/or second tenant at the tenant level.

12. A method according to claim 1, wherein the machine learning model data access hierarchy comprises an administrator level at which a machine learning model is applicable in respect of the first tenant, wherein the administrator level comprises an administrator associated with administrator machine learning model data, and wherein the tenant group belongs to the administrator.

13. A method according to claim 12, the method comprising, for the machine learning model being applied in respect of the first tenant at the administrator level:
allowing access to the administrator machine learning model data, the tenant group machine learning model data and the first tenant machine learning model data; and
inhibiting access to the second tenant machine learning model data.

14. A method according to claim 12, wherein the tenant group level comprises a further tenant group to which at least one further tenant belongs and to which the first and second tenants do not belong, wherein the further tenant group belongs to the administrator, wherein the further tenant group is associated with further tenant group machine learning model data, and wherein the at least one further tenant is associated with further tenant machine learning model data.

15. A method according to claim 14, wherein the method comprises, for the machine learning model being applied in respect of the first tenant at the tenant group level, inhibiting access to the further tenant group machine learning model data and/or the further tenant machine learning model data.

16. A method according to claim 14, wherein the method comprises, for the machine learning model being applied in respect of the first tenant at the administrator level, inhibiting access to the further tenant group machine learning model data and/or the further tenant machine learning model data.

17. A method according to claim 12, wherein the machine learning model data access hierarchy comprises an additional tenant associated with additional tenant machine learning model data, and wherein the additional tenant belongs to the administrator.

18. A method according to claim 17, wherein the method comprises, for the machine learning model being applied in respect of the first tenant at the tenant group level, inhibiting access to the additional tenant machine learning model data.

19. A method according to claim 17, wherein the method comprises, for the machine learning mode being applied in respect of the first tenant at the administrator level, inhibiting access to the additional tenant machine learning model data.

20. A method according to claim 1, wherein the method comprising performing a predetermined action in relation to the tenant group machine learning model data in response to the first and/or second tenant no longer belonging to the tenant group.

21. A method according to claim 1, wherein the machine learning model data comprises machine learning model state data and/or machine learning model parameter data.

22. A method according to claim 1, wherein the tenant group machine learning model data and/or the first tenant machine learning model data is used to perform real-time anomaly detection associated with the first tenant.

23. A method of controlling access to learning model data in a multi-tenant system having a learning model data access hierarchy, the learning model data access hierarchy comprising:
a tenant level comprising first and second tenants associated with first and second tenant learning model data respectively; and
a tenant group level comprising a tenant group to which at least the first tenant belongs, wherein the tenant group is associated with tenant group learning model data, and wherein the tenant group learning model data is based at least on the first tenant learning model data,
the method comprising, for a learning model being applied in respect of the first tenant at the tenant group level and/or for a learning model being applied in respect of the first tenant at the tenant level:
allowing access to the tenant group learning model data and the first tenant learning model data; and
inhibiting access to the second tenant learning model data.

24. A method of controlling access to machine learning model data in a multi-tenant machine learning system having a machine learning model data access hierarchy, the machine learning model data access hierarchy comprising:
a first tenant associated with first tenant machine learning model data;
a second tenant associated with second tenant machine learning model data; and
a tenant group associated with tenant group machine learning model data,
the method comprising controlling access to machine learning model data such that:
at a first time:
the first tenant belongs to the tenant group and the second tenant does not belong to the tenant group; and
the tenant group machine learning model data is based on the first tenant machine learning model data and the tenant group machine learning model data is not based on the second tenant machine learning model data;
at a second, later time:
the first and second tenant belong to the tenant group; and
the tenant group machine learning model data is based at least on the first tenant machine learning model data; and
at a third, later time:
the tenant group machine learning model data is based on the first and second tenant machine learning model data.

25. A multi-tenant machine learning system configured to perform a method according to claim 24.

26. A multi-tenant machine learning system having access to a machine learning model data access hierarchy comprising multiple tenants and one or more tenant groups, the multi-tenant machine learning system comprising a machine learning model data access controller configured to control access to machine learning model data in accordance with the machine learning model data access hierarchy.
